(19) United States
(12) Patent Application Publication
(10) Pub. No.: US 2026/0304196 A1
(43) Pub. Date: Oct. 1, 2026

(54) APPLICABILITY REPORTING

(71) Applicant: QUALCOMM Incorporated, San Diego, CA (US)

(72) Inventors: Rajeev KUMAR, San Diego, CA (US); Aziz GHOLMIEH, Del Mar, CA (US); Punyaslok PURKAYASTHA, San Diego, CA (US)

(21) Appl. No.: 19/575,764

(22) Filed: Mar. 23, 2026

Related U.S. Application Data
(60) Provisional application No. 63/779,102, filed on Mar. 27, 2025.

(51) Int. Cl. H04W 24/10; H04W 24/06

(52) U.S. Cl. CPC H04W 24/10; H04W 24/06

(57) ABSTRACT

Certain aspects of the present disclosure provide techniques for wireless communications. An example method includes obtaining one or more configurations comprising one or more of: an indication of one or more frequencies for measurement prediction for at least a first feature; or an indication of one or more cell identifiers for measurement prediction for at least the first feature; sending an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; obtaining a measurement configuration comprising an indication of one or more measurement objects for at least the first feature; and sending a measurement report based on the measurement configuration.

### CROSS-REFERENCE TO RELATED APPLICATIONS

This application claims the benefit of and priority to U.S. Provisional Patent Application No. 63/779,102, filed on Mar. 27, 2025, the entire contents of which are incorporated herein by reference.

### INTRODUCTION

### Field of the Disclosure

Aspects of the present disclosure relate to wireless communications, and more particularly, to techniques for applicability reporting.

### Description of Related Art

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

One aspect provides a method for wireless communications by an apparatus. The method includes obtaining one or more configurations comprising one or more of: an indication of one or more frequencies for measurement prediction for at least a first feature; or an indication of one or more cell identifiers for measurement prediction for at least the first feature; sending an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; obtaining a measurement configuration comprising an indication of one or more measurement objects for at least the first feature; and sending a measurement report based on the measurement configuration.

Another aspect provides one or more apparatuses configured for wireless communications. The one or more apparatuses comprising a processing system that includes one or more memories coupled with the one or more processors, the processing system configured to cause the one or more apparatuses to: obtain one or more configurations comprising one or more of: an indication of one or more frequencies for measurement prediction for at least a first feature; or an indication of one or more cell identifiers for measurement prediction for at least the first feature; send an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; obtain a measurement configuration comprising an indication of one or more measurement objects for at least the first feature; and send a measurement report based on the measurement configuration.

Another aspect provides one or more apparatuses configured for wireless communications. The one or more apparatuses include: means for obtaining one or more configurations comprising one or more of: an indication of one or more frequencies for measurement prediction for at least a first feature; or an indication of one or more cell identifiers for measurement prediction for at least the first feature; means for sending an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; means for obtaining a measurement configuration comprising an indication of one or more measurement objects for at least the first feature; and means for sending a measurement report based on the measurement configuration.

Another aspect provides one or more non-transitory computer-readable media. The one or more non-transitory computer-readable media include executable instructions that, when executed by one or more processors of one or more apparatuses, cause the one or more apparatuses to: obtain one or more configurations comprising one or more of: an indication of one or more frequencies for measurement prediction for at least a first feature; or an indication of one or more cell identifiers for measurement prediction for at least the first feature; send an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; obtain a measurement configuration comprising an indication of one or more measurement objects for at least the first feature; and send a measurement report based on the measurement configuration.

In some examples of the methods, apparatuses, and non-transitory computer-readable medium described herein, wherein the first feature comprises one of radio resource management prediction, event prediction, handover failure prediction, or radio link failure prediction.

In some examples of the methods, apparatuses, and non-transitory computer-readable medium described herein, the one or more configurations further comprise one or more of: an indication of one or more second frequencies for measurement prediction for at least a second feature; or an indication of one or more second cell identifiers for measurement prediction for at least the second feature; and the applicability report further comprises one or more of: an indication of at least one second frequency, of the one or more second frequencies, selected for measurement prediction for at least the second feature; or an indication of at least one second cell identifier, of the one or more second cell identifiers, selected for measurement prediction for at least the second feature.

In some examples of the methods, apparatuses, and non-transitory computer-readable medium described herein, the measurement configuration further comprises an indication of a measurement report configuration.

In some examples of the methods, apparatuses, and non-transitory computer-readable medium described herein, the measurement report configuration indicates one or more of: a reporting periodicity; a trigger for reporting; or a quantity of measurements for reporting.

In some examples of the methods, apparatuses, and non-transitory computer-readable medium described herein, the one or more measurement objects comprise one or more first measurement objects to measure and one or more second measurement objects to predict.

Some examples of the methods, apparatuses, and non-transitory computer-readable medium described herein may further include operations, features, means, or instructions for obtaining signaling that activates, deactivates, or reconfigures the measurement configuration.

Some examples of the methods, apparatuses, and non-transitory computer-readable medium described herein may further include operations, features, means, or instructions for: obtaining a neighbor cell list; and at least one of: selecting the at least one frequency based on the neighbor cell list; or selecting the at least one cell identifier based on the neighbor cell list.

One aspect provides a method for wireless communications by an apparatus. The method includes obtaining one or more inference configurations, each inference configuration of the one or more inference configurations comprising: an indication of respective one or more first measurement objects for measurement; and an indication of respective one or more second measurement objects for prediction; sending an applicability report comprising: an indication of a first inference configuration of the one or more inference configurations; and sending a measurement report based on the first inference configuration.

Another aspect provides one or more apparatuses configured for wireless communications. The one or more apparatuses comprising a processing system that includes one or more memories coupled with the one or more processors, the processing system configured to cause the one or more apparatuses to: obtain one or more inference configurations, each inference configuration of the one or more inference configurations comprising: an indication of respective one or more first measurement objects for measurement; and an indication of respective one or more second measurement objects for prediction; send an applicability report comprising: an indication of a first inference configuration of the one or more inference configurations; and send a measurement report based on the first inference configuration.

Another aspect provides one or more apparatuses configured for wireless communications. The one or more apparatuses include: means for obtaining one or more inference configurations, each inference configuration of the one or more inference configurations comprising: an indication of respective one or more first measurement objects for measurement; and an indication of respective one or more second measurement objects for prediction; means for sending an applicability report comprising: an indication of a first inference configuration of the one or more inference configurations; and means for sending a measurement report based on the first inference configuration.

Another aspect provides one or more non-transitory computer-readable media. The one or more non-transitory computer-readable media include executable instructions that, when executed by one or more processors of one or more apparatuses, cause the one or more apparatuses to: obtain one or more inference configurations, each inference configuration of the one or more inference configurations comprising: an indication of respective one or more first measurement objects for measurement; and an indication of respective one or more second measurement objects for prediction; send an applicability report comprising: an indication of a first inference configuration of the one or more inference configurations; and send a measurement report based on the first inference configuration.

In some examples of the methods, apparatuses, and non-transitory computer-readable medium described herein: each inference configuration of the one or more inference configurations comprises a respective inference configuration identifier; and the indication of the first inference configuration comprises a first inference configuration identifier of the first inference configuration.

In some examples of the methods, apparatuses, and non-transitory computer-readable medium described herein, each inference configuration of the one or more inference configurations comprises a respective one or more measurement report configurations.

In some examples of the methods, apparatuses, and non-transitory computer-readable medium described herein, each measurement report configuration of the respective one or more measurement report configurations comprises: a respective reporting periodicity; a respective trigger for reporting; or a respective quantity of measurements for reporting.

In some examples of the methods, apparatuses, and non-transitory computer-readable medium described herein, the first inference configuration comprises a network side additional condition associated with a first measurement object of the respective one or more first measurement objects or a second measurement object of the respective one or more second measurement objects.

Some examples of the methods, apparatuses, and non-transitory computer-readable medium described herein may further include operations, features, means, or instructions for obtaining signaling that activates, deactivates, or reconfigures the first inference configuration.

In some examples of the methods, apparatuses, and non-transitory computer-readable medium described herein: the first inference configuration is associated with a first feature; and a second inference configuration of the one or more inference configurations is associated with a second feature.

In some examples of the methods, apparatuses, and non-transitory computer-readable medium described herein, the first feature comprises one of radio resource management prediction, event prediction, handover failure prediction, or radio link failure prediction.

One aspect provides a method for wireless communications by an apparatus. The method includes obtaining configuration information comprising: an indication of one or more measurement objects; sending an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; obtaining an inference configuration comprising: an indication of one or more first measurement objects for measurement; and an indication of one or more second measurement objects for prediction; and sending a measurement report based on the inference configuration.

Another aspect provides one or more apparatuses configured for wireless communications. The one or more apparatuses comprising a processing system that includes one or more memories coupled with the one or more processors, the processing system configured to cause the one or more apparatuses to: obtain configuration information comprising: an indication of one or more measurement objects; send an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; obtain an inference configuration comprising: an indication of one or more first measurement objects for measurement; and an indication of one or more second measurement objects for prediction; and send a measurement report based on the inference configuration.

Another aspect provides one or more apparatuses configured for wireless communications. The one or more apparatuses include: means for obtaining configuration information comprising: an indication of one or more measurement objects; means for sending an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; means for obtaining an inference configuration comprising: an indication of one or more first measurement objects for measurement; and an indication of one or more second measurement objects for prediction; and means for sending a measurement report based on the inference configuration.

Another aspect provides one or more non-transitory computer-readable media. The one or more non-transitory computer-readable media include executable instructions that, when executed by one or more processors of one or more apparatuses, cause the one or more apparatuses to: obtain configuration information comprising: an indication of one or more measurement objects; send an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; obtain an inference configuration comprising: an indication of one or more first measurement objects for measurement; and an indication of one or more second measurement objects for prediction; and send a measurement report based on the inference configuration.

In some examples of the methods, apparatuses, and non-transitory computer-readable medium described herein: the one or more measurement objects comprise: at least one measurement object for measurement; and at least one measurement object for prediction; the one or more respective measurement objects for measurement are selected form the at least one measurement object for measurement; and the one or more respective measurement objects for prediction are selected form the at least one measurement object for prediction.

In some examples of the methods, apparatuses, and non-transitory computer-readable medium described herein, the configuration information further comprises one or more measurement report configurations.

In some examples of the methods, apparatuses, and non-transitory computer-readable medium described herein, each measurement report configuration of the one or more measurement report configurations comprises: a respective reporting periodicity; a respective trigger for reporting; or a respective quantity of measurements for reporting.

In some examples of the methods, apparatuses, and non-transitory computer-readable medium described herein, the applicability report further comprises an indication of one or more respective measurement report configurations, of the one or more measurement report configurations, associated with each set of the one or more sets of measurement objects.

In some examples of the methods, apparatuses, and non-transitory computer-readable medium described herein, the inference configuration comprises an indication of a first measurement report configuration of the one or more measurement report configurations.

In some examples of the methods, apparatuses, and non-transitory computer-readable medium described herein, the configuration information comprises a network side additional condition associated with a first measurement object of the one or more measurement objects.

Some examples of the methods, apparatuses, and non-transitory computer-readable medium described herein may further include operations, features, means, or instructions for: obtaining signaling that activates, deactivates, or reconfigures the inference configuration.

One aspect provides a method for wireless communications by an apparatus. The method includes sending one or more configurations comprising one or more of: an indication of one or more frequencies for measurement prediction for at least a first feature; or an indication of one or more cell identifiers for measurement prediction for at least the first feature; obtaining an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; sending a measurement configuration comprising an indication of one or more measurement objects for at least the first feature; and obtaining a measurement report based on the measurement configuration.

Another aspect provides one or more apparatuses configured for wireless communications. The one or more apparatuses comprising a processing system that includes one or more memories coupled with the one or more processors, the processing system configured to cause the one or more apparatuses to: send one or more configurations comprising one or more of: an indication of one or more frequencies for measurement prediction for at least a first feature; or an indication of one or more cell identifiers for measurement prediction for at least the first feature; obtain an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; send a measurement configuration comprising an indication of one or more measurement objects for at least the first feature; and obtain a measurement report based on the measurement configuration.

Another aspect provides one or more apparatuses configured for wireless communications. The one or more apparatuses include: means for sending one or more configurations comprising one or more of: an indication of one or more frequencies for measurement prediction for at least a first feature; or an indication of one or more cell identifiers for measurement prediction for at least the first feature; means for obtaining an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; means for sending a measurement configuration comprising an indication of one or more measurement objects for at least the first feature; and means for obtaining a measurement report based on the measurement configuration.

Another aspect provides one or more non-transitory computer-readable media. The one or more non-transitory computer-readable media include executable instructions that, when executed by one or more processors of one or more apparatuses, cause the one or more apparatuses to: send one or more configurations comprising one or more of: an indication of one or more frequencies for measurement prediction for at least a first feature; or an indication of one or more cell identifiers for measurement prediction for at least the first feature; obtain an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; send a measurement configuration comprising an indication of one or more measurement objects for at least the first feature; and obtain a measurement report based on the measurement configuration.

In some examples of the methods, apparatuses, and non-transitory computer-readable medium described herein, the first feature comprises one of radio resource management prediction, event prediction, handover failure prediction, or radio link failure prediction.

In some examples of the methods, apparatuses, and non-transitory computer-readable medium described herein: the one or more configurations further comprise one or more of: an indication of one or more second frequencies for measurement prediction for at least a second feature; or an indication of one or more second cell identifiers for measurement prediction for at least the second feature; and the applicability report further comprises one or more of: an indication of at least one second frequency, of the one or more second frequencies, selected for measurement prediction for at least the second feature; or an indication of at least one second cell identifier, of the one or more second cell identifiers, selected for measurement prediction for at least the second feature.

In some examples of the methods, apparatuses, and non-transitory computer-readable medium described herein, the measurement configuration further comprises an indication of a measurement report configuration.

In some examples of the methods, apparatuses, and non-transitory computer-readable medium described herein, the measurement report configuration indicates one or more of: a reporting periodicity; a trigger for reporting; or a quantity of measurements for reporting.

In some examples of the methods, apparatuses, and non-transitory computer-readable medium described herein, the one or more measurement objects comprise one or more first measurement objects to measure and one or more second measurement objects to predict.

Some examples of the methods, apparatuses, and non-transitory computer-readable medium described herein may further include operations, features, means, or instructions for: sending signaling that activates, deactivates, or reconfigures the measurement configuration.

Some examples of the methods, apparatuses, and non-transitory computer-readable medium described herein may further include operations, features, means, or instructions for: sending a neighbor cell list.

One aspect provides a method for wireless communications by an apparatus. The method includes sending one or more inference configurations, each inference configuration of the one or more inference configurations comprising: an indication of respective one or more first measurement objects for measurement; and an indication of respective one or more second measurement objects for prediction; obtaining an applicability report comprising: an indication of a first inference configuration of the one or more inference configurations; and obtaining a measurement report based on the first inference configuration.

Another aspect provides one or more apparatuses configured for wireless communications. The one or more apparatuses comprising a processing system that includes one or more memories coupled with the one or more processors, the processing system configured to cause the one or more apparatuses to: send one or more inference configurations, each inference configuration of the one or more inference configurations comprising: an indication of respective one or more first measurement objects for measurement; and an indication of respective one or more second measurement objects for prediction; obtain an applicability report comprising: an indication of a first inference configuration of the one or more inference configurations; and obtain a measurement report based on the first inference configuration.

Another aspect provides one or more apparatuses configured for wireless communications. The one or more apparatuses include: means for sending one or more inference configurations, each inference configuration of the one or more inference configurations comprising: an indication of respective one or more first measurement objects for measurement; and an indication of respective one or more second measurement objects for prediction; means for obtaining an applicability report comprising: an indication of a first inference configuration of the one or more inference configurations; and means for obtaining a measurement report based on the first inference configuration.

Another aspect provides one or more non-transitory computer-readable media. The one or more non-transitory computer-readable media include executable instructions that, when executed by one or more processors of one or more apparatuses, cause the one or more apparatuses to: send one or more inference configurations, each inference configuration of the one or more inference configurations comprising: an indication of respective one or more first measurement objects for measurement; and an indication of respective one or more second measurement objects for prediction; obtain an applicability report comprising: an indication of a first inference configuration of the one or more inference configurations; and obtain a measurement report based on the first inference configuration.

In some examples of the methods, apparatuses, and non-transitory computer-readable medium described herein, each inference configuration of the one or more inference configurations comprises a respective inference configuration identifier; and the indication of the first inference configuration comprises a first inference configuration identifier of the first inference configuration.

In some examples of the methods, apparatuses, and non-transitory computer-readable medium described herein, each inference configuration of the one or more inference configurations comprises a respective one or more measurement report configurations.

In some examples of the methods, apparatuses, and non-transitory computer-readable medium described herein, each measurement report configuration of the respective one or more measurement report configurations comprises: a respective reporting periodicity; a respective trigger for reporting; or a respective quantity of measurements for reporting.

In some examples of the methods, apparatuses, and non-transitory computer-readable medium described herein, the first inference configuration comprises a network side additional condition associated with a first measurement object of the respective one or more first measurement objects or a second measurement object of the respective one or more second measurement objects.

Some examples of the methods, apparatuses, and non-transitory computer-readable medium described herein may further include operations, features, means, or instructions for: sending signaling that activates, deactivates, or reconfigures the first inference configuration.

In some examples of the methods, apparatuses, and non-transitory computer-readable medium described herein, the first inference configuration is associated with a first feature; and a second inference configuration of the one or more inference configurations is associated with a second feature.

In some examples of the methods, apparatuses, and non-transitory computer-readable medium described herein, the first feature comprises one of radio resource management prediction, event prediction, handover failure prediction, or radio link failure prediction.

One aspect provides a method for wireless communications by an apparatus. The method includes sending configuration information comprising: an indication of one or more measurement objects; obtaining an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; sending an inference configuration comprising: an indication of one or more first measurement objects for measurement; and an indication of one or more second measurement objects for prediction; and obtaining a measurement report based on the inference configuration.

Another aspect provides one or more apparatuses configured for wireless communications. The one or more apparatuses comprising a processing system that includes one or more memories coupled with the one or more processors, the processing system configured to cause the one or more apparatuses to: send configuration information comprising: an indication of one or more measurement objects; obtain an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; send an inference configuration comprising: an indication of one or more first measurement objects for measurement; and an indication of one or more second measurement objects for prediction; and obtain a measurement report based on the inference configuration.

Another aspect provides one or more apparatuses configured for wireless communications. The one or more apparatuses include: means for sending configuration information comprising: an indication of one or more measurement objects; means for obtaining an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; means for sending an inference configuration comprising: an indication of one or more first measurement objects for measurement; and an indication of one or more second measurement objects for prediction; and means for obtaining a measurement report based on the inference configuration.

Another aspect provides one or more non-transitory computer-readable media. The one or more non-transitory computer-readable media include executable instructions that, when executed by one or more processors of one or more apparatuses, cause the one or more apparatuses to: send configuration information comprising: an indication of one or more measurement objects; obtain an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; send an inference configuration comprising: an indication of one or more first measurement objects for measurement; and an indication of one or more second measurement objects for prediction; and obtain a measurement report based on the inference configuration.

In some examples of the methods, apparatuses, and non-transitory computer-readable medium described herein, the one or more measurement objects comprise: at least one measurement object for measurement; and at least one measurement object for prediction; the one or more respective measurement objects for measurement are selected form the at least one measurement object for measurement; and the one or more respective measurement objects for prediction are selected form the at least one measurement object for prediction.

In some examples of the methods, apparatuses, and non-transitory computer-readable medium described herein, the configuration information further comprises one or more measurement report configurations.

In some examples of the methods, apparatuses, and non-transitory computer-readable medium described herein, each measurement report configuration of the one or more measurement report configurations comprises: a respective reporting periodicity; a respective trigger for reporting; or a respective quantity of measurements for reporting.

In some examples of the methods, apparatuses, and non-transitory computer-readable medium described herein, the applicability report further comprises an indication of one or more respective measurement report configurations, of the one or more measurement report configurations, associated with each set of the one or more sets of measurement objects.

In some examples of the methods, apparatuses, and non-transitory computer-readable medium described herein, the inference configuration comprises an indication of a first measurement report configuration of the one or more measurement report configurations.

In some examples of the methods, apparatuses, and non-transitory computer-readable medium described herein, the configuration information comprises a network side additional condition associated with a first measurement object of the one or more measurement objects.

Some examples of the methods, apparatuses, and non-transitory computer-readable medium described herein may further include operations, features, means, or instructions for: sending signaling that activates, deactivates, or reconfigures the inference configuration.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts example beam management procedures.

FIG. 6 depicts an example artificial intelligence (AI) architecture that may be used for AI-enhanced wireless communications.

FIG. 7 illustrates example beam prediction by a UE.

FIG. 8 depicts a process flow for signaling of applicability.

FIG. 9 depicts a method for wireless communications.

FIG. 10 depicts another method for wireless communications.

FIG. 11 depicts another method for wireless communications.

FIG. 12 depicts another method for wireless communications.

FIG. 13 depicts another method for wireless communications.

FIG. 14 depicts another method for wireless communications.

FIG. 15 depicts aspects of an example communications device.

FIG. 16 depicts aspects of an example communications device.

FIG. 17 depicts aspects of an example communications device.

FIG. 18 depicts aspects of an example communications device.

FIG. 19 depicts aspects of an example communications device.

FIG. 20 depicts aspects of an example communications device.

### DETAILED DESCRIPTION

Aspects of the present disclosure provide apparatuses, methods, processing systems, and computer-readable mediums for applicability reporting. In certain aspects, the applicability reporting indicates UE features, UE feature groups, UE functions, or network configurations (e.g., inference configuration or inference configuration information, as further discussed herein) for which a UE can or cannot perform (e.g., artificial intelligence (AI)/machine learning (ML)) inference (e.g., measurement prediction as further discussed herein), such as (e.g., immediately) after network configuration or activation of the UE feature, UE feature group, UE function, or network configuration. For example, an applicability report may indicate the UE features, UE feature groups, UE functions, or network configurations for which a UE can obtain an AI/ML inference (e.g., measurement prediction), such as (e.g., immediately) after network configuration or activation. Additionally or alternatively, the applicability report may indicate UE features, UE feature groups, UE functions, or network configurations for which a UE cannot obtain an AI/ML inference (e.g., measurement prediction), such as (e.g., immediately) after network configuration or activation, such as due to not having a trained AI/ML model for such inference, having access to a trained AI/ML model for such inference but needing to download the model so it is not immediately available, temporarily not having sufficient available computational resources or memory for performing the inference, etc.

In certain aspects, such as for mobility use cases, an applicability report may indicate UE features, UE feature groups, UE functions, or network configurations a UE supports for performing mobility operations, such as radio resource measurement (RRM) prediction or beam prediction, as further discussed herein. Though certain aspects are discussed with respect to RRM prediction and/or beam prediction, it should be noted that the techniques discussed herein are applicable to a variety of different types of inference performed by the UE, including for other mobility use cases. For example, aspects discussed with respect to beam prediction may similarly apply to RRM prediction, or vice versa.

For example, an applicability report may indicate one or more applicable and/or non-applicable AI/ML enabled UE features, UE feature groups, UE functions, or network configurations, which may include or be associated with one or more resources for measurement, such as one or more measurement objects for measurement (e.g., one or more cells, synchronization signal block (SSB) beams, (CSI)-reference signals (RSs) beams, one or more frequencies, one or more time-frequency resources, etc. a UE is configured to measure), and/or one or more resources for prediction, such as one or more measurement objects for prediction (e.g., one or more cells, synchronization signal block (SSB) beams, (CSI)-reference signals (RSs) beams, one or more frequencies, one or more time-frequency resources, etc. a UE is configured to predict), and/or one or more measurement report configurations (e.g., for reporting measurements and/or prediction results, or any combination of them). In certain aspects, a UE can report UE capability information to indicate support for AI/ML enabled UE features or UE feature groups, and in certain aspects, associated properties such as size of input/output for the UE features or UE feature groups. In certain aspects, activated UE features, UE feature groups, UE functions, or network configuration refer to UE features, UE feature groups, UE functions or network configuration already enabled for performing inference at the UE.

The term “beam” may be used in the present disclosure in various contexts. Beam may be used to mean a set of gains and/or phases (e.g., precoding weights or co-phasing weights) applied to antenna elements in (or associated with) a wireless communication device for transmission or reception. The term “beam” may also refer to an antenna or radiation pattern of a signal transmitted while applying the gains and/or phases to the antenna elements. Other references to beam may include one or more properties or parameters associated with the antenna (or radiation) pattern, such as an angle of arrival (AoA), an angle of departure (AoD), a gain, a phase, a directivity, a beam width, a beam direction (with respect to a plane of reference) in terms of azimuth and/or elevation, a peak-to-side-lobe ratio, and/or an antenna (or precoding) port associated with the antenna (radiation) pattern. The term “beam” may also refer to an associated number and/or configuration of antenna elements (e.g., a uniform linear array, a uniform rectangular array, or other uniform array).

Certain wireless communication systems (e.g., a 5^{th} generation (5G) New Radio (NR) system and/or any future system) may use beamforming for directional signal transmission and/or reception to facilitate efficient and reliable wireless communications. As an example, beamforming may apply various amplitude weighting and/or phase shift patterns across multiple antennas to focus transmission or reception of wireless signals in a particular spatial direction (e.g., azimuth and/or elevation) and/or beamwidth generally defining a beam. In particular, efficient and reliable communications may be achieved through various beam management techniques such as beamforming, beam selection (e.g., the process of selecting a beam to use for wireless communications), beam failure detection procedure(s) (e.g., the process of detecting when communications via a beam do not meet a quality or reliability specification, such as a particular data error rate), beam failure recovery procedure(s) (e.g., the process of selecting an alternative beam when beam failure is detected for a particular beam used for communications), or the like. Such beam management techniques may be critical to achieving the high data rates, low latency, and/or high reliability that various generations of wireless technologies promise to deliver.

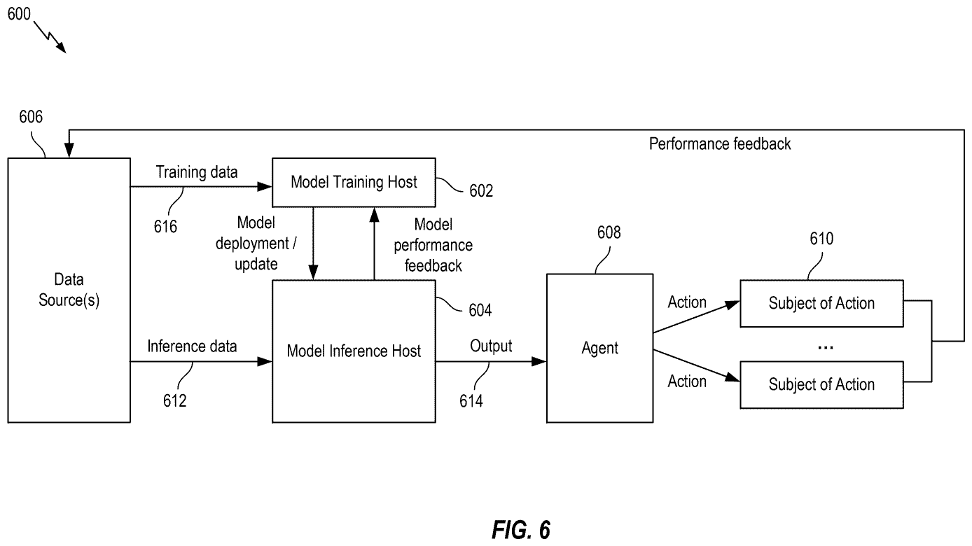

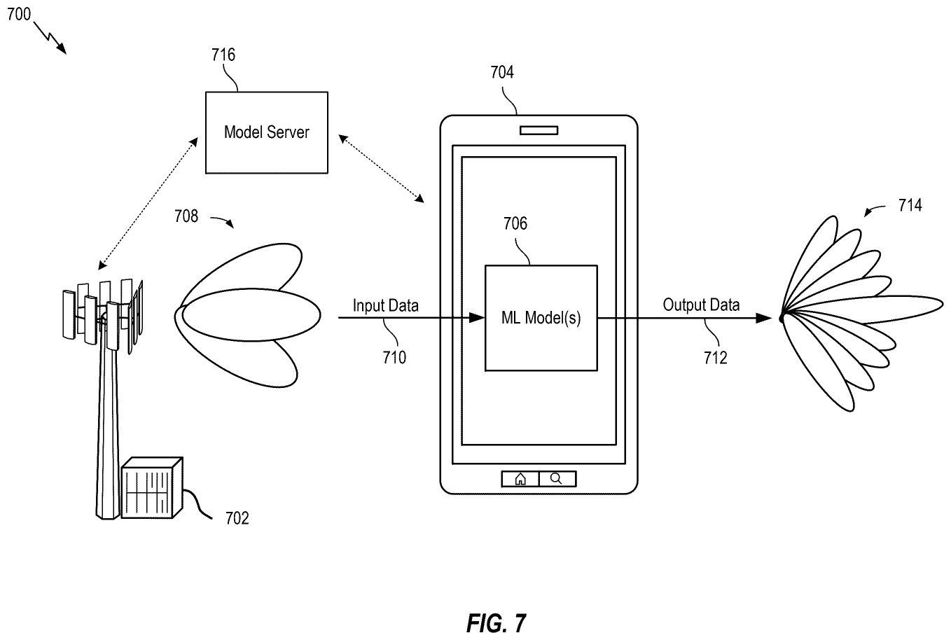

In certain cases, beam management may be enabled through certain artificial intelligence (AI)-based beam predictions, such as spectral beam predictions, temporal beam predictions, and/or spatial beam predictions, for example, as further described herein with respect to FIGS. 6 and 7. A prediction functionality may be a function, ML model, algorithm, process, or the like, configured to make a prediction, such as of channel characteristics. Though certain aspects discussed herein refer to AI-based beam predictions, it should be noted that the techniques discussed herein are also applicable to other types of adaptable prediction functionality, such as RRM predictions.

As used herein, AI-based prediction may refer to prediction(s) derived from one or more AI models, such as one or more machine learning (ML) models. As an example, a UE may use a ML model to form certain predictions for a set of A-beams (such as temporal and/or spatial beam predictions) based on measurement results of a set of B-beams. The set of A-beams may be referred to as “Set-A beams,” and the set of B-beams may be referred to as “Set-B beams.” For example, the UE may monitor reference signals associated with the Set-B beams, such as synchronization signaling (e.g., synchronization signal block (SSB) transmissions), channel state information (CSI)-reference signals (RSs), demodulation reference signals (DMRSs), or the like. Then, the UE may provide measurements of the reference signals associated with the Set-B beams to the ML model, and the UE may obtain predictions associated with the Set-A beams from the ML model based on the measurements of the reference signals associated with the Set-B beams.

As used herein, the Set-A beams may be referred to as or may include prediction targets. The AI-based predictions (e.g., on the Set-A beams) may include predicting channel characteristics on the prediction targets (e.g., prediction results). The predicted channel characteristics (e.g., the prediction results) on the prediction targets may include one or more of: identifiers of TopK prediction targets (e.g., a subset of the prediction targets, where K≥1) with respect to reference signal received power (RSRP) measurements, signal-to-interference-plus-noise ratio (SINR) measurements, and/or probabilities (e.g., which prediction targets and/or beams of the Set-A beams have highest RSRP measurements, SINR measurements, and/or probabilities of being the top prediction target); predicted Layer 1 (L1)-RSRP measurements and/or L1-SINR measurements, such as on the TopK prediction targets, all prediction targets, etc.; probabilities being Top1/TopK prediction target(s) of the TopK prediction targets (e.g., probabilities that a respective prediction target is a top prediction target); or confidence information on the predicted L1-RSRP measurements and/or L1-SINR measurements (e.g., a numerical value or range that indicates how likely the predicted L1-RSRP measurements and/or L1-SINR measurements made by an ML model is to be accurate). The Set-B beams may be referred to as or may include measurement resources to be used to derive the predicted channel characteristics on the prediction targets.

One or more technical problems may arise for AI-based mobility, such as AI-based RRM predictions (e.g., cells, SSB beams, CSI-RS beams, radio measurements prediction over intra/inter frequency or in future time instances), mobility event prediction (e.g., whether or when one or more configured events for mobility are expected to be triggered), radio link failure prediction (e.g., whether or when a UE is expected to experience radio link failure due to different causes, for example, T310 timer expiry, max radio link control (RLC) retransmission, beam failure and its recovery failures, T312 timer expiry associated with target cell or beam measurements, etc.), handover failure prediction (e.g., whether or when UE is expected to experience handover failure associated with a configured handover command, secondary cell group (SCG) addition or change command, any combination thereof), or any combinations thereof at a UE. In certain aspects, whether a UE supports one or more such UE features, UE feature groups, UE functions, and/or associated configuration(s) can be indicated to the network using one or more static capabilities (also referred to as static factors) and/or one or more dynamic capabilities (also referred to as dynamic factors).

Example capabilities (e.g., static capabilities) may include for what UE feature or feature group information an AI model of the UE is configured to make predictions, a maximum number of inputs to an AI model of the UE, or a maximum number of outputs from an AI model of the UE. In certain aspects, a UE feature or feature group may include radio resource management prediction, event prediction, handover failure prediction, or radio link failure prediction. In certain aspects, a maximum number of inputs to an AI model of the UE may include a maximum number of cells and corresponding beams (e.g., SSBs or CSI-RSs) the UE can measure as input parameters to the AI model. In certain aspects, a maximum number of outputs from an AI model of the UE may include a maximum number of cells and corresponding beams (e.g., SSBs or CSI-RSs) the UE can predict as output parameters from the AI model.

Example capabilities (e.g., dynamic capabilities) may include AI model availability at the UE, measurements object(s) the UE is configured to predict, measurement object(s) the UE is configured to measure, a reporting configuration (also referred to as a measurement report configuration) of the UE, or network side additional conditions. AI model availability my include what AI model(s) are available at the UE for use for prediction. For example, a UE may have limited storage capability and may download different AI models that are then available to the UE at different times. A reporting configuration may indicate to a UE information as to when, how, etc. to report measurements (e.g., actual measurements and/or predicted measurements), such as to a network entity. For example, the reporting configuration may indicate one or more reporting criteria (e.g., one or more trigger events for reporting, such as a measurement event, a reporting periodicity, etc.), a reference signal type (e.g., the reference signal that the UE uses for beam and cell measurement results), or a reporting format (e.g., the quantities of measurements for reporting, such as per cell and per beam that the UE includes in a measurement report (e.g., the maximum number of cells and the maximum number of beams per cell to report)). Network side additional conditions may include network specific conditions related to prediction, such as cell specific information (e.g., height of a cell, transmit power, etc.), cell layout information, communication conditions, communication scenarios, communication factors, etc. Network side additional conditions may be used, for example, to indicate which measurement objects may be associated with additional conditions, which may affect their selection for prediction and/or measurement.

A network entity may be configured to send an indication of an inference configuration (e.g., a measurement configuration) to a UE. In certain aspects, an inference configuration may indicate one or more measurement objects (e.g., and a measurement report configuration), such as for the UE to measure and/or predict. However, the inference configuration suitable for a UE may be based on capabilities of the UE. Accordingly, there is a technical problem of how to ensure that the network entity can configure the UE to use an inference configuration that is compatible with the capabilities of the UE.

Aspects described herein may overcome the aforementioned technical problem(s), for example, by providing technical solutions including signaling between the network entity and the UE to aid in configuration of the UE with an inference configuration that is compatible with the capabilities of the UE. Technical benefits of such technical solutions may include improved prediction performance of the UE, which may help to achieve the high data rates, low latency, and/or high reliability that various generations of wireless technologies promise to deliver, as discussed.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

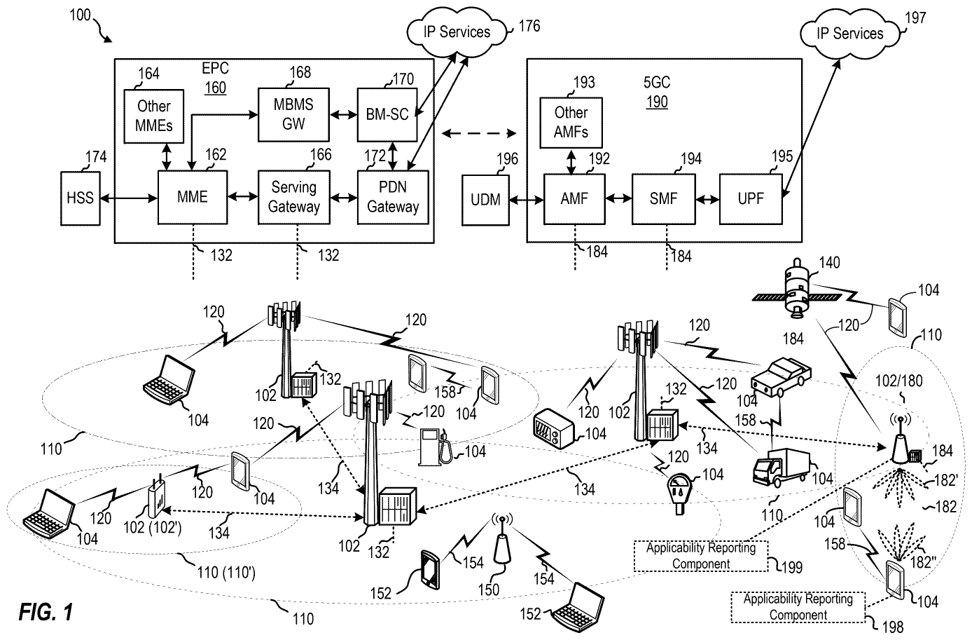

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a next generation NodeB (gNB) implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

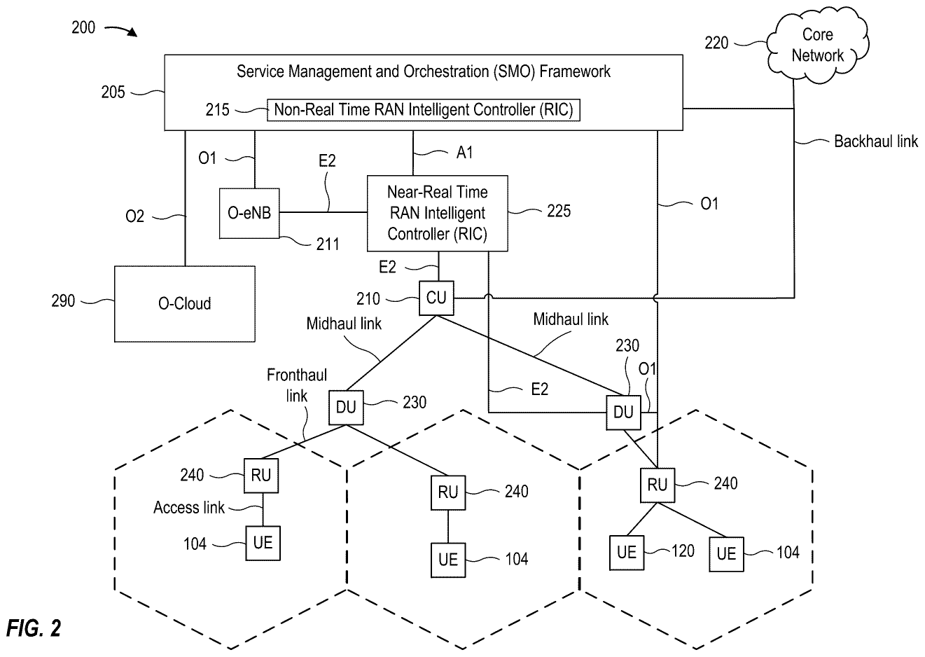

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G NR or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 megahertz (MHz)-7125 MHz, which is often referred to (interchangeably) as “Sub- 6 gigahertz (GHz)”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182′′. UE 104 may also transmit a beamformed signal to the BS 180 in one or more transmit directions 182′′. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information. 5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes an applicability reporting component 198, which may be used for performing applicability reporting, such as for AI-based beam predictions at the UE 104 as further described herein. Further, a BS 102 includes an applicability reporting component 199, which may be used for applicability reporting, such as for AI-based beam predictions at a UE 104 as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUs 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3^{rd} Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

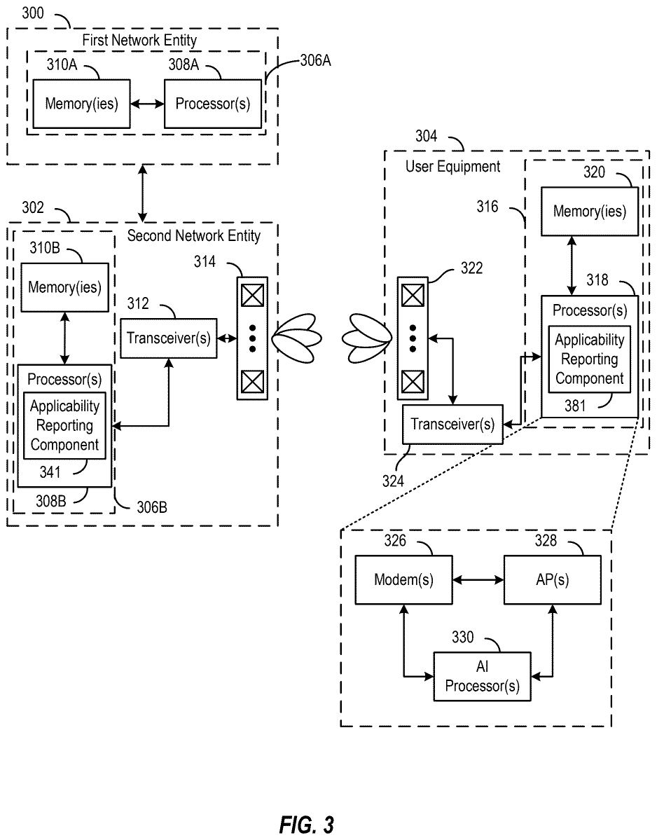

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In s ome examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306A” at first network entity 300 and “processing system 306B” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308A” and “processor(s) 308B”) and one or more memories 310 (illustrated as “memory(ies) 310A” and “memory(ies) 310B”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a transmit (TX) MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, a receive (RX) MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for single-carrier frequency division multiplexing (SC-FDM)), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306B such as a modem and/or an RX MIMO detector), and further processed by the processing system 306B (e.g., a modem and/or a receive processor) to obtain decoded data and control information sent by UE 304. The processing system 306B may provide the decoded data and the decoded control information (such as to a controller/processor of the processing system 306B, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

In the depicted example, the processor(s) 308B includes an applicability reporting component 341, which may be representative of the applicability reporting component 199 of FIG. 1. Notably, while depicted as an aspect of processor(s) 308B, the applicability reporting component 341 may be implemented additionally or alternatively in various other aspects of a network entity or a BS 102 in other implementations. Further, the processor(s) 318 includes an applicability reporting component 381, which may be representative of the applicability reporting component 198 of FIG. 1. Notably, while depicted as an aspect of the processor(s) 318, the applicability reporting component 381 may be implemented additionally or alternatively in various other aspects of a UE 104 in other implementations.

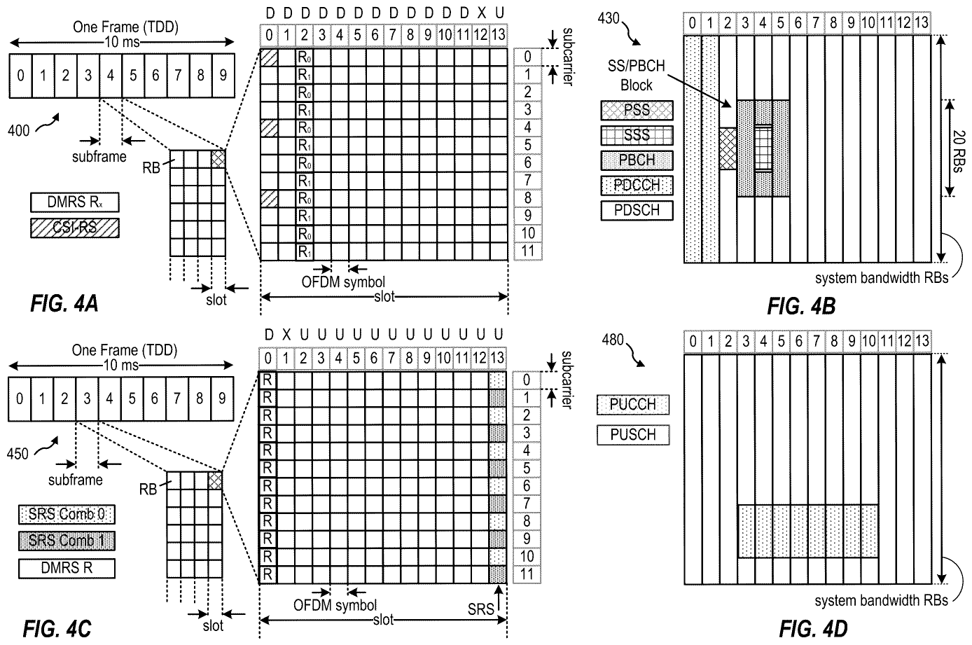

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology μ, there are 2^{μ}slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 2^{μ}×15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The reference signal (RS) may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgement (ACK)/negative acknowledgement (NACK) feedback. The PUSCH carries data, and may additionally be used to carry a buffer status report (BSR), a power headroom report (PHR), and/or UCI.

### Example Beam Management Procedures

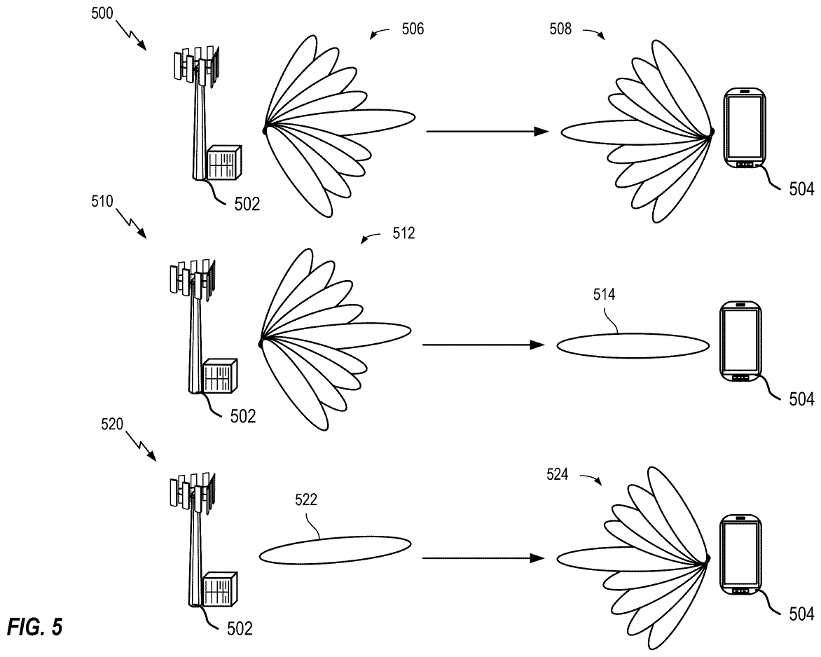

FIG. 5 is a diagram illustrating examples 500, 510, and 520 of beam management procedures. As shown in FIG. 5, examples 500, 510, and 520 include a UE 504 in communication with a BS 502 in a wireless network (e.g., wireless communications network 100 in FIG. 1). In some aspects, the BS 502 may be an example of the BS 102 depicted and described with respect to FIG. 1, the first network entity 300 or the second network entity 302 depicted and described with respect to FIG. 3, or a disaggregated base station depicted and described with respect to FIG. 2. Similarly, the UE 504 may be an example of the UE 104 depicted and described with respect to FIG. 1 or the UE 304 depicted and described with respect to FIG. 3. However, the devices shown in FIG. 5 are provided as examples, and the wireless network may support communication and beam management between other devices (e.g., between a UE 504 and a network entity, a UE 504 and a transmission reception point (TRP), between a mobile termination node and a control node, between an integrated access and backhaul (IAB) child node and an IAB parent node, between a scheduled node and a scheduling node, and/or the like). In some aspects, the UE 504 and the BS 502 are in a connected state (e.g., RRC connected state and/or the like).

BS 502 and UE 504 may communicate to perform beam management using reference signals (RSs) (e.g., synchronization (SSBs), demodulation reference signals (DM-RSs), channel state information reference signals (CSI-RSs), etc.).

Example 500 depicts a first beam management procedure (e.g., such as a P1 CSI-RS beam management procedure). The first beam management procedure may be referred to as a beam selection procedure, an initial beam acquisition procedure, a beam sweeping procedure, a cell search procedure, a beam search procedure, and/or the like. In example 500, reference signals are configured to be transmitted from the BS 502 to UE 504. The reference signals may be configured to be periodic (e.g., using RRC signaling), semi-persistent (e.g., using media access control (MAC) control element (MAC-CE) signaling), and/or aperiodic (e.g., using downlink control information (DCI)).

As illustrated, the first beam management procedure may include BS 502 performing beam sweeping over multiple TX beams 506. A transmit beam is a beam that is used by a wireless communication device (e.g., a BS 502 and/or UE 504) for transmitting signals. For example, BS 502 may transmit a reference signal using each of the transmit beams 506 associated with BS 502 for beam management. To enable UE 504 to perform RX beam sweeping, BS 502 uses a transmit beam to transmit (e.g., with repetitions) each reference signal at multiple times within a same resource set to enable UE 504 to sweep through receive beams 508 in multiple transmission instances. A receive beam is a beam that is used by a wireless communication device for receiving signals. For example, if BS 502 has a set of N transmit beams 506 and UE 504 has a set of M receive beams 508, then the reference signal may be transmitted on each of the N transmit beams 506 M times such that UE 504 receives M instances of the reference signals per transmit beam. As a result, the first beam management procedure helps to enable UE 504 to measure a reference signal on different transmit beams, using different receive beams, to support the selection of a receive beam for a transmit beam. UE 504 may report the measurements to BS 502 to enable BS 502 to select one or more beam pair(s) for communication between BS 502 and UE 504, as further described herein with respect to channel state feedback corresponding to receive beam hypotheses.

Example 510, illustrated in FIG. 5, depicts a second beam management procedure (e.g., such as a P2 CSI-RS beam management procedure). The second beam management procedure may be referred to as a beam refinement procedure, a BS beam refinement procedure, a TRP beam refinement procedure, a transmit beam refinement procedure, and/or the like.

As illustrated, the second beam management procedure includes BS 502 performing beam sweeping over one or more transmit beams 512. The transmit beam(s) 512 may be a subset of all transmit beams associated with BS 502 (e.g., determined based, at least in part, on measurements reported by UE 504 in connection with the first beam management procedure). BS 502 transmits a reference signal using each of the transmit beam(s) 512. UE 504 measures each reference signal using a single (e.g., a same) receive beam 514 (e.g., determined based, at least in part, on measurements performed in connection with the first beam management procedure). As such, the second beam management procedure may enable BS 502 to select a best transmit beam based on measurements of the reference signals (e.g., measured by UE 504 using the single receive beam 514) reported by UE 504.

Example 520, illustrated in FIG. 5, depicts a third beam management procedure (e.g., such as a P3 CSI-RS beam management procedure). The third beam management procedure may be referred to as a beam refinement procedure, a UE beam refinement procedure, a receive beam refinement procedure, and/or the like.

As illustrated, the third beam management procedure includes BS 502 transmitting one or more reference signals using a single transmit beam 522 (e.g., determined based, at least in part, on measurements reported by UE 504 in connection with the first beam management procedure and/or the second beam management procedure). To enable UE 504 to perform receive beam sweeping, BS 502 may use a transmit beam to transmit (e.g., with repetitions) reference signals at multiple times within a same resource set such that UE 504 can sweep through one or more receive beams 524 in multiple transmission instances. The receive beam(s) 524 may be a subset of all receive beams associated with UE 504 (e.g., determined based on measurements performed in connection with the first beam management procedure and/or the second beam management procedure). The third beam management procedure helps to enable BS 502 and/or UE 504 to select a best receive beam based on reported measurements received from UE 504 (e.g., of the reference signal of the transmit beam using the one or more receive beams).

FIG. 5 is provided as an example of beam management procedures for determining transmit beam(s) and/or receive beam(s) for wireless communications between a UE and a network entity. Other examples of beam management procedures that differ from what is described with respect to FIG. 5, however, may be considered when determining transmit beam(s) and/or receive beam(s) for wireless communications.

### Example Artificial Intelligence for Wireless Communications

Certain aspects described herein may be implemented, at least in part, using some form of artificial intelligence (AI), e.g., the process of using a machine learning (ML) model to infer or predict output data based on input data. An example ML model may include a mathematical representation of one or more relationships among various objects to provide an output representing one or more predictions or inferences. Once an ML model has been trained, the ML model may be deployed to process data that may be similar to, or associated with, all or part of the training data and provide an output representing one or more predictions or inferences based on the input data.

ML is often characterized in terms of types of learning that generate specific types of learned models that perform specific types of tasks. For example, different types of machine learning include supervised learning, unsupervised learning, semi-supervised learning, and reinforcement learning.

Supervised learning algorithms generally model relationships and dependencies between input features (e.g., a feature vector) and one or more target outputs. Supervised learning uses labeled training data, which are data including one or more inputs and a desired output. Supervised learning may be used to train models to perform tasks like classification, where the goal is to predict discrete values, or regression, where the goal is to predict continuous values. Some example supervised learning algorithms include nearest neighbor, naive Bayes, decision trees, linear regression, support vector machines (SVMs), and artificial neural networks (ANNs).

Unsupervised learning algorithms work on unlabeled input data and train models that take an input and transform it into an output to solve a practical problem. Examples of unsupervised learning tasks are clustering, where the output of the model may be a cluster identification, dimensionality reduction, where the output of the model is an output feature vector that has fewer features than the input feature vector, and outlier detection, where the output of the model is a value indicating how the input is different from a typical example in the dataset. An example unsupervised learning algorithm is k-Means.

Semi-supervised learning algorithms work on datasets containing both labeled and unlabeled examples, where often the quantity of unlabeled examples is much higher than the number of labeled examples. However, the goal of a semi-supervised learning is that of supervised learning. Often, a semi-supervised model includes a model trained to produce pseudo-labels for unlabeled data that is then combined with the labeled data to train a second classifier that leverages the higher quantity of overall training data to improve task performance.

Reinforcement learning algorithms use observations gathered by an agent from an interaction with an environment to take actions that may maximize a reward or minimize a risk. Reinforcement learning is a continuous and iterative process in which the agent learns from its experiences with the environment until it explores, for example, a full range of possible states. An example type of reinforcement learning algorithm is an adversarial network. Reinforcement learning may be particularly beneficial when used to improve or attempt to optimize a behavior of a model deployed in a dynamically changing environment, such as a wireless communication network.

ML models may be deployed in one or more devices (e.g., network entities such as base station(s) and/or user equipment(s)) to support various wired and/or wireless communication aspects of a communication system. For example, an ML model may be trained to identify patterns and relationships in data corresponding to a network, a device, an air interface, or the like. An ML model may improve operations relating to one or more aspects, such as transceiver circuitry controls, frequency synchronization, timing synchronization, channel state estimation, channel equalization, channel state feedback, modulation, demodulation, device positioning, transceiver tuning, beamforming, signal coding/decoding, network routing, load balancing, and energy conservation (to name just a few) associated with communications devices, services, and/or networks. AI-enhanced transceiver circuitry controls may include, for example, filter tuning, transmit power controls, gain controls (including automatic gain controls), phase controls, power management, and the like.

Aspects described herein may describe the performance of certain tasks and the technical solution of various technical problems by application of a specific type of ML model, such as an ANN. It should be understood, however, that other type(s) of AI models may be used in addition to or instead of an ANN. An ML model may be an example of an AI model, and any suitable AI model may be used in addition to or instead of any of the ML models described herein. Hence, unless expressly recited, subject matter regarding an ML model is not necessarily intended to be limited to just an ANN solution or machine learning. Further, it should be understood that, unless otherwise specifically stated, terms such “AI model,” “ML model,” “AI/ML model,” “trained ML model,” and the like are intended to be interchangeable.

FIG. 6 is a diagram illustrating an example AI architecture 600 that may be used for AI-enhanced wireless communications. As illustrated, the architecture 600 includes multiple logical entities, such as a model training host 602, a model inference host 604, data source(s) 606, and an agent 608. The AI architecture may be used in any of various use cases for wireless communications, such as those listed above.

The model inference host 604, in the architecture 600, is configured to run an ML model based on inference data 612 provided by data source(s) 606. The model inference host 604 may produce an output 614 (e.g., a prediction or inference, such as a discrete or continuous value) based on the inference data 612, that is then provided as input to the agent 608. In certain aspects, the model inference host 604 may be an example of a model inference agent.

The agent 608 may be an element or an entity of a wireless communication system including, for example, a radio access network (RAN), a wireless local area network, a device-to-device (D2D) communications system, etc. In certain examples, the agent 608 may be an example of a decision agent. In some examples, the agent 608 may be a UE, a base station, or any disaggregated network entity thereof including a CU, a DU, and/or an RU, an access point, a wireless station, a RIC in a cloud-based RAN, among some examples. Additionally, the type of agent 608 may also depend on the type of tasks performed by the model inference host 604, the type of inference data 612 provided to model inference host 604, and/or the type of output 614 produced by model inference host 604.

For example, if output 614 from the model inference host 604 is associated with mobility, the agent 608 may be or include a UE, a DU, or an RU. As another example, if output 614 from model inference host 604 is associated with transmission and/or reception scheduling, the agent 608 may be a CU or a DU.

After the agent 608 receives output 614 from the model inference host 604, agent 608 may determine whether to act based on the output. For example, if agent 608 is a DU or an RU and the output from model inference host 604 is associated with mobility, the agent 608 may determine whether to change or modify a transmit and/or receive beam, perform handover, or perform other mobility based on the output 614. If the agent 608 determines to act based on the output 614, agent 608 may indicate the action to at least one subject of the action 610. For example, if the agent 608 determines to change or modify a transmit beam and/or receive beam, perform handover, or perform other mobility for a communication between the agent 608 and the subject of action 610 (e.g., a UE), the agent 608 may send an indication to the subject of action 610 (e.g., a UE). As another example, the agent 608 may be a UE, the output 614 from model inference host 604 may be one or more predicted channel characteristics, such as for one or more measurement objects. For example, the model inference host 604 may predict channel characteristics, such as for a set of measurement objects based on the measurements of another set of measurement objects. Based on the predicted channel characteristics, the agent 608, such as the UE, may send, to the subject of action 610, such as a BS, a request for mobility. In some cases, the agent 608 and the subject of action 610 are the same entity.

The data sources 606 may be configured for collecting data that is used as training data 616 for training an ML model, or as inference data 612 for feeding an ML model inference operation. In particular, the data sources 606 may collect data from any of various entities (e.g., the UE and/or the BS), which may include the subject of action 610, and provide the collected data to a model training host 602 for ML model training. For example, after a subject of action 610 (e.g., a UE) receives a configuration from agent 608, the subject of action 610 may provide performance feedback associated with the configuration to the data sources 606, where the performance feedback may be used by the model training host 602 for monitoring and/or evaluating the ML model performance, such as whether the output 614, provided to agent 608, is accurate. In some examples, if the output 614 provided to agent 608 is inaccurate (or the accuracy is below an accuracy threshold), the model training host 602 may determine to modify or retrain the ML model used by model inference host 604, such as via an ML model deployment/update.

In certain aspects, the model training host 602 may be deployed at or with the same or a different entity than that in which the model inference host 604 is deployed. For example, in order to offload model training processing, which can impact the performance of the model inference host 604, the model training host 602 may be deployed at a model server as further described herein. Further, in some cases, training and/or inference may be distributed amongst devices in a decentralized or federated fashion.

AI/ML techniques have been introduced to help reduce the complexity involved in mobility and the overhead associated with mobility without sacrificing system performance. For example, with the help of ML techniques, mobility may be performed in a fraction of the time taken by conventional exhaustive search methods and with performance comparable to that of such methods.

In certain aspects, an ML model is deployed at or on a UE (e.g., such as UE 104 in FIG. 1), for example, for purposes of spatial domain (SD), temporal domain (TD), and/or frequency domain (FD) prediction. The TD refers to the analytic space in which signals are conveyed in terms of time. The FD refers to the analytic space in which signals are conveyed in terms of frequency. A scenario where the ML model, at or on the UE, is used to predict SD downlink beams for a set of A-beams (referred to as “Set-A beams”) based on measurement results of a set of B-beams (referred to as “Set-B beams”) may be referred to as a beam management case 1, or simply “BM-Case1.” Additionally, a scenario where the ML model, at or on the UE, is used to predict TD downlink beams for Set-A beams based on the historic measurement results of a set of B-beams may be referred to as a beam management case 2, or simply “BM-Case2.” In general, in certain aspects, ML may be used to predict characteristics associated with the Set-A beams, and the set of B-beams may be used for DL beam measurements as input data for the ML. For BM-Case1 and BM-Case2, the beams in the Set-A beams and the set of B-beams may be in the same Frequency Range (e.g., FR1 and/or FR2). In some cases, the set of B-beams may be a subset of the Set-A beams. There may be any number of beams in each of the Set-A beams and the set of B-beams. There may be quasi-colocation (QCL) relationships between the Set-A beams and the set of B-beams.

FIG. 7 is a diagram illustrating example beam prediction 700 by a UE. In this example, one or more ML models (hereinafter “the ML model 706”) are deployed at or on the UE 704 to enable the UE 704 to make one or more beam predictions based on data input to ML model 706. The UE 704 may be an example of UE 104 depicted and described with respect to FIG. 1, the UE 304 depicted and described with respect to FIG. 3, or the UE 504 depicted and described with respect to FIG. 5. Though FIG. 7 discusses beam prediction, a similar ML model 706 may be used for other types of prediction, such as RRM prediction.

A network node 702 (e.g., a base station or any disaggregated entity thereof) may transmit one or more signals (e.g., SSB(s), DM-RS(s), CSI-RS(s)), such as via a first set of transmit beams 708, in a first set of communication resources (e.g., an SSB resource, a DM-RS resource, and/or a CSI-RS resource), such as corresponding to a first set of measurement objects. The network node 702 may be an example of the BS 102 depicted and described with respect to FIG. 1, the first network entity 300 or the second network entity 302 depicted and described with respect to FIG. 3, a disaggregated base station depicted and described with respect to FIG. 2, or the BS 502 depicted and described with respect to FIG. 5.

The UE 704 may perform measurements (e.g., L1-RSRP measurements and/or other measurements) of the one or more signals transmitted in the first set of communication resources, or a subset thereof, to obtain input data, which may include a first set of measurements 710 (sometimes referred to as parameters, channel characteristics, or channel properties). For example, each transmit beam (or a subset thereof), from the first set of transmit beams 708 carrying the signal(s), may be associated with one or more measurements 710 performed by UE 704. The UE 704 may feed the first set of measurements 710 (e.g., L1 RSRP measurement values) into the ML model 706. The UE 704 may further feed information associated with the first set of beams and/or first set of communication resources (or a subset thereof). The information associated with the first set of beams may include a beam direction (e.g., a spatial direction), beam width, beam shape, and/or other characteristics of the respective beam.

The ML model 706 may provide output data, for example, including an indication of a second set of measurements 712. As part of AI-based beam prediction, the second set of measurements 712 may include one or more predicted measurement values for a second set of communication resources, such as corresponding to a second set of measurement objects, such as associated with a second set of transmit beams 714. As an example, the second set of measurements 712 may include one or more predicted channel characteristics (e.g., predicted L1-RSRP measurement values) associated with the second set of communication resources, such as where the second set of communication resources are associated with the second set of transmit beams 714. In certain cases, the UE 704 may perform measurements of one or more signals transmitted in the second set of communication resources, or a subset thereof, to obtain the second set of measurements 712, for example, as a part of training data collection and/or performance monitoring for the ML model 706.

In some examples, the first set of transmit beams 708 (e.g., that are measured) may be referred to as “Set-B beams” and the second set of transmit beams 714 (e.g., that are associated with predicted measurements for the second set of communication resources) may be referred to as “Set-A beams.” Put another way, the “Set-B beams” are a set of beams for which measurements are taken and used to determine input data based on such measurements for the ML model 706, whereas the “Set-A beams” are a set of beams for which ML model 706 performs predictions.

In some examples, the first set of transmit beams 708 are a subset of the second set of transmit beams 714. In some other examples, the first set of transmit beams 708 and the second set of transmit beams 714 are different beams and/or may be mutually exclusive sets. For example, the first set of transmit beams 708 may include wide beams (e.g., unrefined beams or beams having a beam width that satisfies a first threshold), and the second set of transmit beams 714 may include narrow beams (e.g., refined beams or beams having a beam width that satisfies a second threshold).

Use of the ML model 706 for prediction may reduce a quantity of measurements that are performed by the UE 704 (e.g., compared to exhaustive search methods described above with respect to FIG. 6), thereby conserving power at the UE 704 and/or network resources, such as that would have otherwise been used to measure all beams included in at least the first set of beams.

In some aspects, this type of prediction may be referred to as a codebook-based SD selection or prediction. The codebook-based SD prediction/selection may be associated with an initial access, a secondary cell group (SCG) setup, a serving beam refinement, and/or a link quality (e.g., channel quality indicator (CQI) or precoding matrix indicator (PMI)) and interference adaptation.

As another example, an output of the ML model 706 may include a point-direction, an angle of departure (AoD), and/or an angle of arrival (AoA) of a beam included in the second set of transmit beams 714 (e.g., the “Set-A beams”). This type of prediction may be referred to as a non-codebook-based SD selection or prediction. The non-codebook-based prediction/selection may be associated with a serving beam refinement, and/or a link quality (e.g., CQI or PMI) and interference adaptation. As another example, multiple measurement reports and/or values, collected at different points in time, may be input to the ML model 706. This may enable the ML model 706 to output codebook-based and/or non-codebook-based predictions for a measurement value, an AoD, and/or an AoA, among other examples, of a beam at a future time. The output(s) of the ML model 706, may facilitate initial access procedures, carrier aggregation (e.g., secondary cell setup), dual connectivity (e.g., secondary cell group (SCG) setup), beam refinement procedures (e.g., a P2 beam management procedure and/or a P3 beam management procedure as described above with respect to FIG. 5), link quality or interference adaptation procedures, beam failure and/or beam blockage predictions, and/or radio link failure predictions, among other examples.

In certain aspects, an output of the ML model 706 may include a temporal prediction, such as a TD beam prediction or TD RRM prediction. The TD beam prediction may be associated with a serving beam refinement, a link quality (e.g., CQI or PMI) and interference adaptation, a beam failure/blockage prediction, and/or a radio link failure (RLF) prediction.

In certain aspects, the ML model 706 performs SD downlink beam predictions for beams included in the “Set-A beams” based on measurement results of beams included in the “Set-B beams.” In some aspects, the ML model 706 performs TD downlink beam prediction for beams included in the “Set-A beams” based on historic measurement results of beams included in the “Set-B beams.”

In certain aspects, a model server 716 (in communication with the UE 704 and/or the network node 702) may perform any of various ML model lifecycle management (LCM) tasks for the UE 704 and/or the network node 702. The model server 716 may operate as the model training host 602 (e.g., depicted and described with respect to FIG. 6) and update the ML model 706 using training data. In some cases, the model server 716 may operate as the data source 606 (e.g., depicted and described with respect to FIG. 6) to collect and host training data, inference data, and/or performance feedback associated with an ML model 706. In certain aspects, the model server 716 may host various types and/or versions of the ML model 706 for the UE 704 and/or the network node 702 to download.

In some cases, the model server 716 may monitor and evaluate the performance of the ML model 706 to trigger one or more LCM tasks. For example, the model server 716 may determine whether to activate or deactivate the use of a particular ML model at the UE 704 and/or the network node 702, and the model server 716 may provide such an instruction to the respective UE 704 and/or the network node 702. In some cases, the model server 716 may determine whether to switch to a different ML model 706 being used at the UE 704 and/or the network node 702, and the model server 716 may provide such an instruction to the respective UE 704 and/or the network node 702. In yet further examples, the model server 716 may also act or operate as a central server for decentralized machine learning tasks, such as federated learning.

### Example Signaling for Applicability Reporting

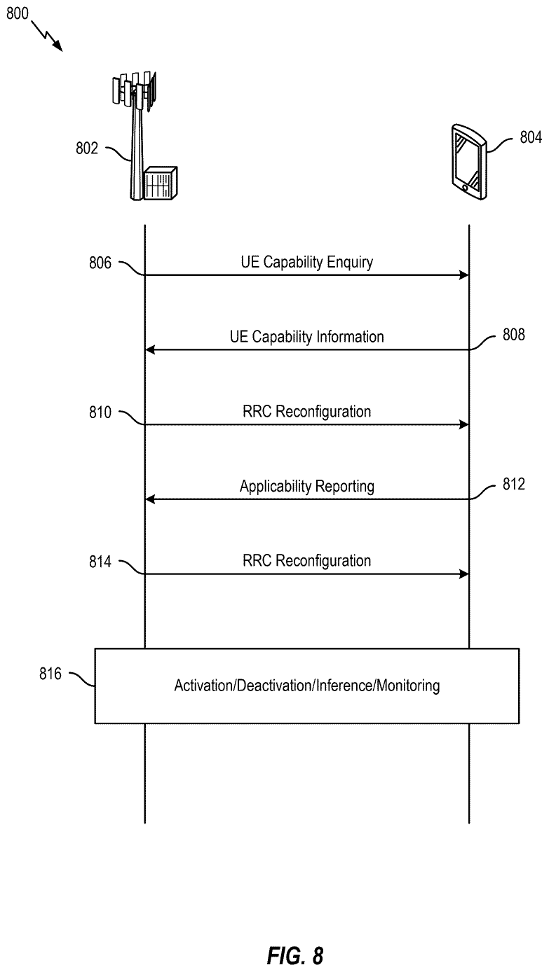

FIG. 8 depicts a process flow 800 for signaling of applicability reporting in a network between a network entity 802 and a UE 804. In some aspects, the network entity 802 may be an example of the BS 102 depicted and described with respect to FIG. 1, the first network entity 300 or the second network entity 302 depicted and described with respect to FIG. 3, a disaggregated base station depicted and described with respect to FIG. 2, the BS 502 depicted and described with respect to FIG. 5, or the network node 702 depicted and described with respect to FIG. 7. Similarly, the UE 804 may be an example of UE 104 depicted and described with respect to FIG. 1, the UE 304 depicted and described with respect to FIG. 3, the UE 504 depicted and described with respect to FIG. 5, or the UE 704 depicted and described with respect to FIG. 7. However, in other aspects, UE 804 may be another type of wireless communications device and network entity 802 may be another type of network entity or network node, such as those described herein.

At 806, the network entity 802 may send a capability enquiry message to the UE 804 (e.g., a UECapabilityEnqiry message). In some aspects, the capability enquiry message may initiate a procedure for the UE 804 to report its prediction functionalities (e.g., AI/ML supported functionalities).

At 808, the UE 804 may send a capability information message (e.g., UECapablityInformation message) to the network entity 802. In some aspects, the capability information message may include or indicate supported AI/ML enabled UE feature(s), UE feature group(s), or function(s) (e.g., RRM measurement prediction, mobility event prediction, radio link failure prediction, handover failure prediction, etc.) at the UE 804. For example, the UE capability information message may indicate whether the UE 804 supports intra-frequency RRM prediction, inter-frequency RRM prediction, temporal RRM prediction over intra/inter frequency, or any combination thereof. In some aspects, the capabilities indicated by the UE 804 in the capability information message may include “static” capabilities (e.g., static factors), such as those discussed.

At 810, the network entity 802 may send a message, such as a reconfiguration message (e.g., RRCReconfiguration message) to the UE 804. In certain aspects, the message may include one or more configurations (e.g., one or more inference configurations), or configuration information (e.g., inference configuration information), as further discussed herein. In some aspects, the one or more configurations may indicate that the UE 804 is allowed to do UE-assistance information (UAI) reporting via a corresponding configuration (e.g., OtherConfig and/or the CSI-ReportConfigs) and/or that the network entity 802 may provide network-side additional condition(s).

After receiving the reconfiguration message, the UE 804 may determine the applicable functionalities (e.g., ML model(s) availability at the device, measurement object(s) for measurement, measurement object(s) for prediction, measurement report configuration(s), etc.) it supports, such as based on one or more of: the network-side conditions (e.g., if provided), UE-side conditions (e.g., internally known by UE), and an ML model availability in the UE 804. In some aspects, the UE may consider other configurations (e.g., an inference configuration) when determining the applicable functionalities it supports.

The inference configuration may indicate the input data to provide an ML model for the interference operations. In certain aspects, the inference configuration may indicate the output data to estimate or predict using the ML model. Note that “inference operation(s)” or “inference” may refer to operationalization of a trained ML model. For example, an inference operation may include using the trained ML model to generate predictions, estimations, or the like. As another example, an inference operation may include using the trained ML model for compression and/or decompression, for example, of CSI and/or any other suitable payload communicated between a UE and a network entity.

At 812, the UE 804 may send an applicability report to the network entity 802. For example, the UE 804 may report, to the network entity 802, indication of one or more applicable or non-applicable UE features, UE feature groups, functions, one or more configurations (e.g., one or more inference configurations), or configuration information (e.g., inference configuration information). In some aspects, the UE 804 may report applicability in the following scenarios: upon being configured to provide applicability and upon change of applicability via UAI and/or as a response to network-side additional condition requesting applicability reporting at 810. Additionally or alternatively, the UE 804 may report applicability based on other network configurations (e.g., an inference configuration).

At 814, the network entity 802 may send an additional message, such as an additional reconfiguration message (e.g., RRCReconfiguration message) to the UE 804. In some aspects, the additional message may include an inference configuration, such as a measurement configuration. For example, the network entity 802 may configure an inference configuration to the UE 804 after the applicability reporting, such as including applicable and non-applicable UE features, feature groups, functions, one or more configurations (e.g., one or more inference configurations), or configuration information (e.g., inference configuration information), at 812 if an inference configuration based on supported functionality is not provided at 810 (e.g., the inference configuration is then provided at 814). Additionally or alternatively, if an inference configuration based on supported functionality is provided at 810, it may be up to network implementation whether to provide an updated configuration or not at 814.

In certain aspects, the inference configuration (e.g., per feature as discussed further herein) may be activated, deactivated, or reconfigured based on the additional message at 814.

In certain aspects, the inference configuration (e.g., per feature) may be activated based on additional signaling (e.g., L1 or L2 signaling, RRC signaling, L3 signaling, etc.) such as at 816. For example, at 816, the network entity 802 may send to the UE 804 additional signaling that activates or deactivates an inference configuration, such as per feature. As another example, at 816, the network entity 802 may send to the UE 804 additional signaling that reconfigures an inference configuration, such as per feature.

In certain aspects, at 816, the UE 804 and the network entity 802 may communicate based on the inference configuration activated. For example, the UE 804 and the network entity 802 may activate or deactivate an inference configuration, a prediction functionality, a performance monitoring, or another use-case. In some aspects, the network entity 802 may use dynamic signaling (e.g., RRC configuration, L3 indication, MAC-CE and/or DCI). For example, UE 804 may measure one or more first measurement objects, and utilize measurements of the one or more first measurement objects to predict one or more second measurement objects. The UE 804 may further send a measurement report based on the inference configuration to network entity 802. For example, the measurement report may include measurement(s) of at least one of the one or more first measurement objects and/or at least one of the one or more second measurement objects.

### Example Content for Applicability Reporting Messages

In certain aspects, one or more steps of the process flow 800 for signaling of applicability reporting may be used for signaling between the network entity 802 and the UE 804 to aid in configuration of the UE 804 with an inference configuration that is compatible with the capabilities of the UE 804. In particular, in certain aspects, the content of one or more messages of process flow 800 may include information that aids in configuration of the UE 804 with an inference configuration that is compatible with the capabilities of the UE 804. As discussed, technical benefits of such signaling may include improved prediction performance of the UE, which may help to achieve high data rates, low latency, and/or high reliability.

In certain aspects, the message at 810 includes one or more of: an indication of one or more frequencies (e.g., one or more absolute radio frequency channel numbers (ARFCNs)) for measurement prediction (e.g., at the UE using an AI model) for at least a first feature; or an indication of one or more cell identifiers (IDs) (e.g., cell global identity (CGI), physical cell identifier (PCI), beam identifiers (e.g., SSB index or CSI-RS resource or resource sets), etc.) for measurement prediction for at least the first feature. For example, the message 810 may indicate frequenc(ies), cell ID(s), and/or associated beam identifier(s) that may be used to determine one or more measurement objects for UE 804 to measure and/or predict. In certain aspects, the message 810 includes an indication of one or more frequencies, one or more cell IDs, and/or one or more associated beam identifiers per feature (e.g., radio resource management prediction, event prediction, handover failure prediction, or radio link failure prediction). For example, each feature may be associated with one or more respective frequencies, one or more respective cell IDs, and/or one or more respective associated beam identifiers. Accordingly, different features may be associated with different measurement objects, such that different measurement objects may be measured and/or predicted for different features.

In certain aspects, the applicability report at 812 includes one or more of: an indication of at least one frequency, of the one or more frequencies, selected for measurement prediction for at least the first feature; an indication of at least one cell identifier, of the one or more cell identifiers, selected for measurement prediction for at least the first feature; or an indication of at least one beam identifier, of the one or more respective associated beam identifiers, selected for measurement prediction for at least the first feature. For example, the at least one beam identifier may include an SSB or CSI-RS beam identifier selected per cell or across cells, of one or more SSB or CSI-RS beam identifier selected per cell or across cells, selected for measurement prediction for at least the first feature. For example, the UE 804 may select at least one frequency of the one or more frequencies indicated in message 810 and/or select at least one cell ID and/or beam identifier of the one or more cell IDs and/or associated beam identifiers indicated in message 810, such as per feature. The UE 804 may make the selections based on, for example, capabilities of the UE 804, such as which ML models are available at the UE 804, which may have been trained on one or more measurement objects.

In certain aspects, network entity 802 is configured to send to UE 804 a neighbor cell list, such as in system information (e.g., SIB4, SIB5, an AI based mobility specific SIB, etc.). A neighbor cell list may indicate (e.g., using cell IDs) one or more neighbor cells (e.g., cells that are geographically proximate or adjacent) of the network entity 802. In certain aspects, the at least one frequency and/or at least one cell ID and/or beam identifier selected at 812 may be based on the neighbor cell list, such as correspond to a cell ID and frequency used by a cell in the neighbor cell list.

In certain aspects, the additional message at 814 includes a measurement configuration including an indication of one or more measurement objects for at least the first feature. In certain aspects, the one or more measurement objects may be based on the at least one frequency and/or at least one cell ID and/or at least one associated beam identifier indicated in the applicability report, such as one or more measurements objects within the at least one frequency, associated with a network entity associated with the at least one cell ID, and associated with a beam (e.g., SSB or CSI-RS) associated with the at least one beam identifier. The one or more measurement objects may include one or more first measurement objects to measure and one or more second measurement objects to predict. For example, the additional message at 814 may include an inference configuration. In certain aspects, the measurement configuration further includes an indication of a measurement report configuration, as discussed, such as the measurement report configuration itself. Accordingly, based on additional message 814, UE 804 may be configured with a measurement configuration that may be used by UE 804 for measurement object measurement, measurement object prediction, and/or measurement reporting.

### Example Content for Applicability Reporting Messages

In certain aspects, the message at 810 includes one or more one or more inference configurations. For example, each of the one or more inference configurations may include an indication of respective one or more first measurement objects for measurement (e.g., by the UE) and respective one or more second measurement objects for prediction (e.g., by the UE, such as based on measurements of the one or more first measurement objects). In certain aspects, different inference configurations of the one or more inference configurations may be associated with different features.

Further, in certain aspects, each of the one or more inference configurations may include a respective inference configuration identifier (e.g., measID that links measurement object(s) and measurement report configuration(s)), which may be used to identify the inference configuration.

In certain aspects, each inference configuration of the one or more inference configurations may include a respective one or more measurement report configurations. For example, each inference configuration may link measurement object(s) to measurement report configuration(s).

In certain aspects, some (e.g., all, one, a subset, etc.) of the one or more measurement configurations may include respective one or more network side additional conditions, such as associated with at least one of the one or more first measurement objects or at least one of the one or more second measurement objects. For example, different measurements objects may be associated with or have different network side additional conditions related to their measurement and/or prediction.

Accordingly, message 810 may configure UE 804 with inference configurations that may be used by UE 804 for measurement object measurement, measurement object prediction, and/or measurement reporting.

In certain aspects, the applicability report at 812 includes an indication (e.g., inference configuration identifier) of a first inference configuration of the one or more inference configurations included in message 810. For example, the first inference configuration may be an applicable inference configuration that the UE 804 utilizes for measurement object measurement, measurement object prediction, and/or measurement reporting. Based on sending applicability report at 812, UE 804 may activate the first inference configuration and begin operating according to the first inference configuration. UE 804 may select the first inference configuration based on, for example, capabilities of the UE 804, such as which ML models are available at the UE 804, which may have been trained on different measurement objects associated with different inference configurations.

In certain aspects, the applicability report at 812 includes an indication of multiple inference configurations, such as associated with different features, such that the UE 804 may activate different inference configurations for different features.

### Example Content for Applicability Reporting Messages

In certain aspects, the message at 810 includes configuration information (e.g., inference configuration information). In certain aspects, such configuration information corresponds to information that may be used, at least in part, to determine an inference configuration, such as for UE 804.

In certain aspects, the configuration information includes an indication of one or more measurement objects (e.g., {MO₁,MO₂, . . . , MO_{K}}, where MO_{K} represents a Kth measurement object). In certain aspects, the configuration information does not indicate whether the one or more measurement objects are potentially for measurement purposes or for prediction purposes. In certain other aspects, the indication of the one or more measurement objects indicates at least one measurement object for measurement (e.g., {MOI₁, MOI₂, . . . , MOI_{K}}, where MOI_{K} represents a Kth measurement object for measurement) and at least one measurement object for prediction (e.g., {MOO₁, MOO₂, . . . , MOO_{Z}}, where MOO_{Z} represents a Zth measurement object for prediction). For example, a measurement of a measurement object for measurement may be used as input to an AI model that is configured to output predicted measurement(s) for measurement object(s) for prediction.

In certain aspects, the configuration information includes one or more network side additional conditions, such as configured together with the one or more measurement objects. In certain aspects, some (e.g., all, one, a subset, etc.) of the one or more measurement objects (e.g., measurement object for prediction and/or measurement object for measurement) may be associated with respective one or more network side additional conditions. For example, different measurements objects may be associated with or have different network side additional conditions.

In certain aspects, the configuration information includes one or more measurement report configurations (e.g., {RC₁, RC₂, . . . , RC_{L}}, where RC_{L} represents an Lth measurement report configuration).

In certain aspects, the applicability report at 812 includes an indication of one or more sets of measurement objects. In certain aspects, each set of measurement objects of the one or more measurement objects includes one or more respective measurement objects for measurement and one or more respective measurement objects for prediction. In certain aspects, each of the one or more respective measurement objects for measurement and one or more respective measurement objects for prediction are selected from the same one or more measurement objects indicated in message 810. In certain aspects, the one or more respective measurement objects for measurement are selected from the at least one measurement object for measurement indicated in message 810 and the one or more respective measurement objects for prediction are selected from the at least one measurement object for prediction indicated in message 810.

For example, UE 804 may be configured to select sets (e.g., tuples, combinations, etc.) of measurement object(s) for prediction and measurement object(s) for measurement, and report the sets to network entity 802. For example, each set may correspond to a possible inference configuration that UE 804 can support, such as based on capabilities of UE 804, such as which ML models are available at the UE 804, which may have been trained on different measurement objects. For example, a given ML model may support or be more suitable for a certain combination of measurement object measurements as input and measurement object predictions as output.

In certain aspects, the applicability report at 812 includes, associated with each set of the one or more sets of measurements objects, an indication of one or more respective measurement report configurations, such as of the one or more measurement report configurations included in message 810. For example, UE 804 may be configured to select one or more combinations of one or more measurement objects for measurement (e.g., for input to an AI model), one or more measurement objects for prediction (e.g., for output from the AI model), and one or more measurement report configurations (e.g., for reporting the measurements of the one or more measurement objects for measurement and/or one or more measurement objects for prediction), such as based on UE capabilities.

In certain aspects, the applicability report 812 includes one or more tuples, each tuple corresponding to a possible inference configuration for UE 804. Each tuple may indicate one or more measurement objects for measurement (e.g., for input to an AI model), one or more measurement objects for prediction (e.g., for output from the AI model), and, in some cases, one or more measurement report configurations (e.g., for reporting the measurements of the one or more measurement objects for measurement and/or one or more measurement objects for prediction). Example tuples include: (AMOIₚ: {MOI₁, MOI₂, . . . , MOI_{M}}, AMOOₚ: {MOO₁, MOO₂, . . . , MOO_{N}}|ARCₚ: {RC₁, RC₂, . . . , RC_{Q}}), where AMOIₚ⊆MOI, AMOOₚ⊆MOO, ARCₚ⊆RC, and where AMOIₚ is the pth measurement object combination for measurement, AMOOₚ is the pth measurement object combination for prediction, ARCₚ is the pth corresponding measurement report configuration(s), for a pth inference configuration, MOI_{M} represents an Mth measurement object for measurement, MOO_{N} represents a Nth measurement object for prediction, and RC_{Q} represents a Qth measurement report configuration.

In certain aspects, the additional message 814 includes an inference configuration. The inference configuration may include an indication of one or more first measurement objects for measurement and an indication of one or more second measurement objects for prediction. The inference configuration may further include an indication of a first measurement report configuration.

For example, network entity 802 may be configured to generate and configure UE 804 with an inference configuration based on the applicability report at 812, such as based on the sets (e.g., one of the sets) of measurement object(s) (e.g., and the associated measurement report configuration(s)). For example, the inference configuration may correspond to one of the combinations of one or more measurement objects for measurement, one or more measurement objects for prediction, and, in some cases, one or more measurement report configurations. Accordingly, UE 804 may be configured with an inference configuration based on identification of possible inference configurations that UE 804 may support in applicability report 812.

Accordingly, based on additional message 814, UE 804 may be configured with an inference configuration that may be used by UE 804 for measurement object measurement, measurement object prediction, and/or measurement reporting.

### Example Operations of a User Equipment

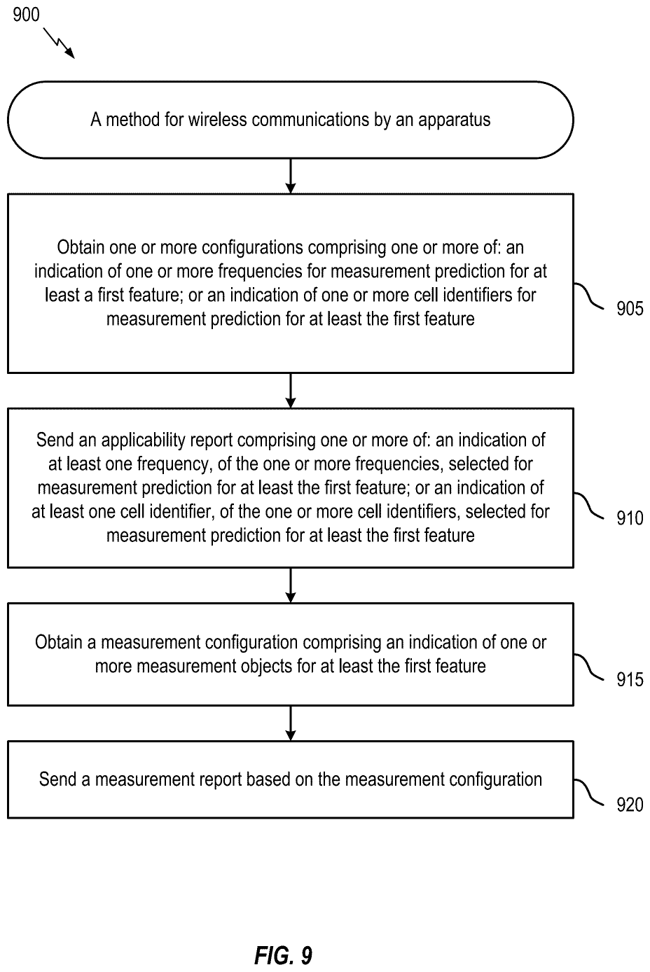

FIG. 9 shows a method 900 for wireless communications by an apparatus, such as UE 104 of FIG. 1, UE 304 of FIG. 3, UE 504 of FIG. 5, UE 704 of FIG. 7, or UE 804 of FIG. 8.

Method 900 begins at block 905 with obtaining one or more configurations comprising one or more of: an indication of one or more frequencies for measurement prediction for at least a first feature; or an indication of one or more cell identifiers for measurement prediction for at least the first feature.

Method 900 then proceeds to block 910 with sending an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature.

Method 900 then proceeds to block 915 with obtaining a measurement configuration comprising an indication of one or more measurement objects for at least the first feature.

Method 900 then proceeds to block 920 with sending a measurement report based on the measurement configuration.

In some aspects, the first feature comprises one of radio resource management prediction, event prediction, handover failure prediction, or radio link failure prediction.

In some aspects, the one or more configurations further comprise one or more of: an indication of one or more second frequencies for measurement prediction for at least a second feature; or an indication of one or more second cell identifiers for measurement prediction for at least the second feature; and the applicability report further comprises one or more of: an indication of at least one second frequency, of the one or more second frequencies, selected for measurement prediction for at least the second feature; or an indication of at least one second cell identifier, of the one or more second cell identifiers, selected for measurement prediction for at least the second feature.

In some aspects, the measurement configuration further comprises an indication of a measurement report configuration.

In some aspects, the measurement report configuration indicates one or more of: a reporting periodicity; a trigger for reporting; or a quantity of measurements for reporting.

In some aspects, the one or more measurement objects comprise one or more first measurement objects to measure and one or more second measurement objects to predict.

In some aspects, method 900 further includes obtaining signaling that activates, deactivates, or reconfigures the measurement configuration.

In some aspects, method 900 further includes obtaining a neighbor cell list.

In some aspects, method 900 further includes at least one of: selecting the at least one frequency based on the neighbor cell list; or selecting the at least one cell identifier based on the neighbor cell list.

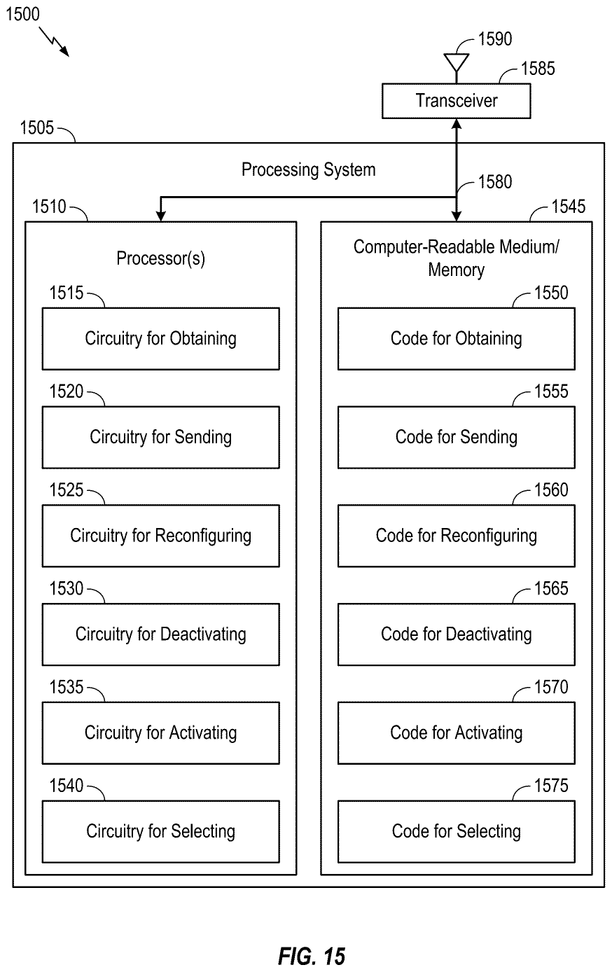

In some aspects, method 900, or any aspect related to it, may be performed by an apparatus, such as communications device 1500 of FIG. 15, which includes various components operable, configured, or adapted to perform the method 900. Communications device 1500 is described below in further detail.

Note that FIG. 9 is just one example of a method, and other methods including fewer, additional, or alternative operations are possible consistent with this disclosure.

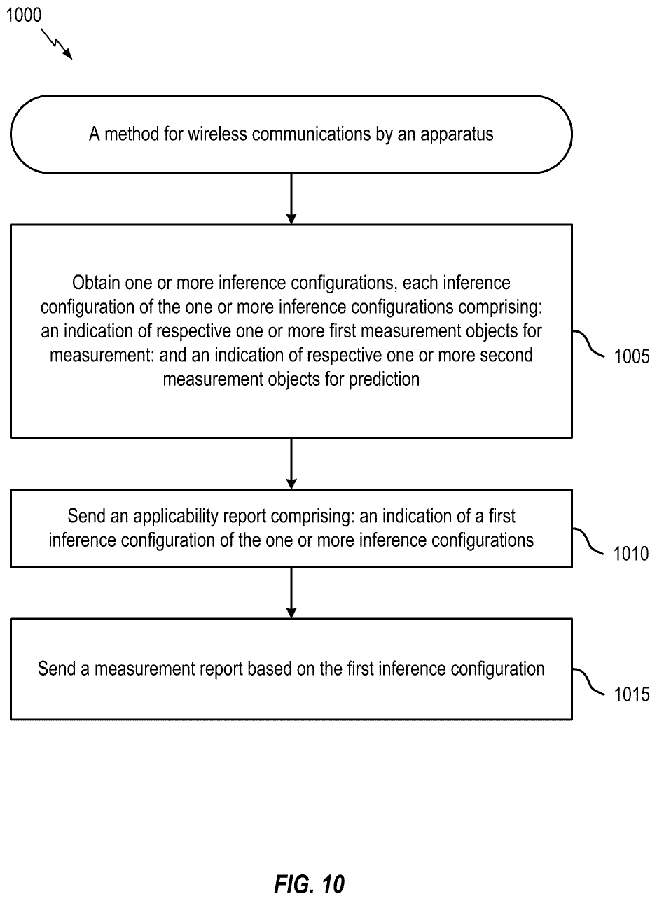

FIG. 10 shows a method 1000 for wireless communications by an apparatus, such as UE 104 of FIG. 1, UE 304 of FIG. 3, UE 504 of FIG. 5, UE 704 of FIG. 7, or UE 804 of FIG. 8.

Method 1000 begins at block 1005 with obtaining one or more inference configurations, each inference configuration of the one or more inference configurations comprising: an indication of respective one or more first measurement objects for measurement; and an indication of respective one or more second measurement objects for prediction.

Method 1000 then proceeds to block 1010 with sending an applicability report comprising: an indication of a first inference configuration of the one or more inference configurations.

Method 1000 then proceeds to block 1015 with sending a measurement report based on the first inference configuration.

In some aspects, each inference configuration of the one or more inference configurations comprises a respective inference configuration identifier; and the indication of the first inference configuration comprises a first inference configuration identifier of the first inference configuration.

In some aspects, each inference configuration of the one or more inference configurations comprises a respective one or more measurement report configurations.

In some aspects, each measurement report configuration of the respective one or more measurement report configurations comprises: a respective reporting periodicity; a respective trigger for reporting; or a respective quantity of measurements for reporting.

In some aspects, the first inference configuration comprises a network side additional condition associated with a first measurement object of the respective one or more first measurement objects or a second measurement object of the respective one or more second measurement objects.

In some aspects, method 1000 further includes obtaining signaling that activates, deactivates, or reconfigures the first inference configuration.

In some aspects, the first inference configuration is associated with a first feature; and a second inference configuration of the one or more inference configurations is associated with a second feature.

In some aspects, the first feature comprises one of radio resource management prediction, event prediction, handover failure prediction, or radio link failure prediction.

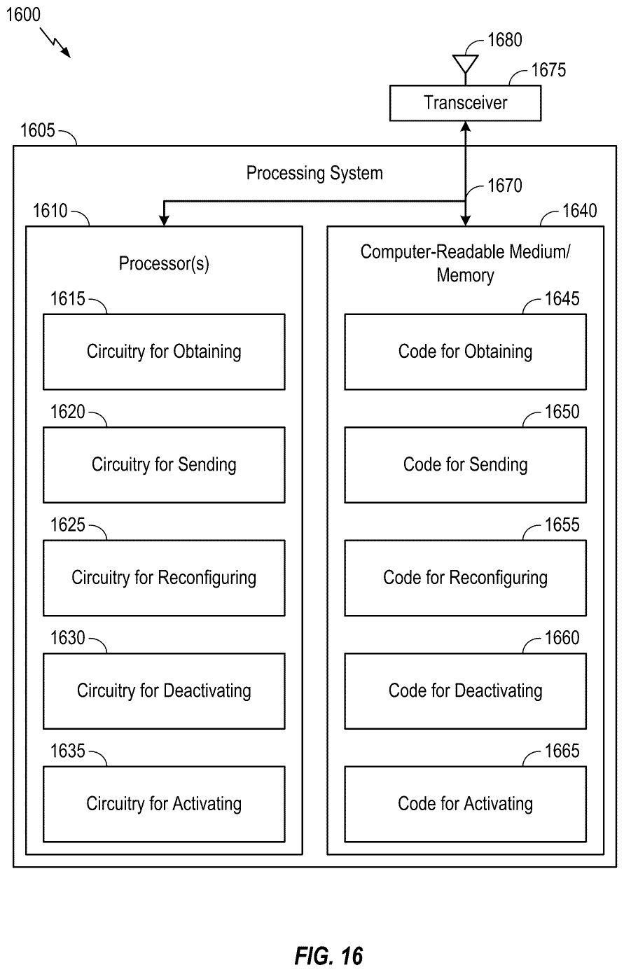

In some aspects, method 1000, or any aspect related to it, may be performed by an apparatus, such as communications device 1600 of FIG. 16, which includes various components operable, configured, or adapted to perform the method 1000. Communications device 1600 is described below in further detail.

Note that FIG. 10 is just one example of a method, and other methods including fewer, additional, or alternative operations are possible consistent with this disclosure.

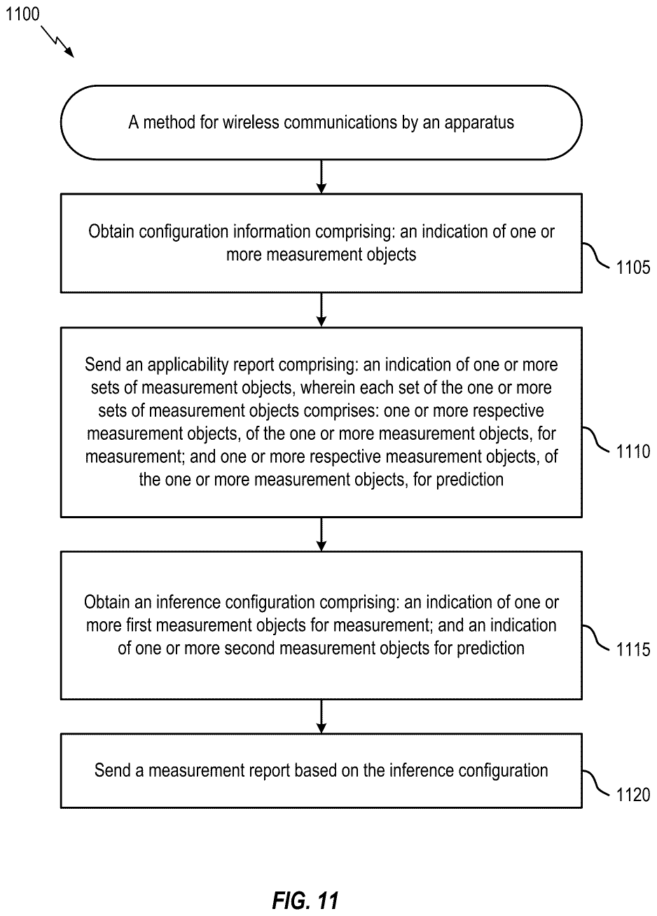

FIG. 11 shows a method 1100 for wireless communications by an apparatus, such as UE 104 of FIG. 1, UE 304 of FIG. 3, UE 504 of FIG. 5, UE 704 of FIG. 7, or UE 804 of FIG. 8.

Method 1100 begins at block 1105 with obtaining configuration information comprising: an indication of one or more measurement objects.

Method 1100 then proceeds to block 1110 with sending an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction.

Method 1100 then proceeds to block 1115 with obtaining an inference configuration comprising: an indication of one or more first measurement objects for measurement; and an indication of one or more second measurement objects for prediction.

Method 1100 then proceeds to block 1120 with sending a measurement report based on the inference configuration.

In some aspects, the one or more measurement objects comprise: at least one measurement object for measurement; and at least one measurement object for prediction; the one or more respective measurement objects for measurement are selected form the at least one measurement object for measurement; and the one or more respective measurement objects for prediction are selected form the at least one measurement object for prediction.

In some aspects, the configuration information further comprises one or more measurement report configurations.

In some aspects, each measurement report configuration of the one or more measurement report configurations comprises: a respective reporting periodicity; a respective trigger for reporting; or a respective quantity of measurements for reporting.

In some aspects, the applicability report further comprises an indication of one or more respective measurement report configurations, of the one or more measurement report configurations, associated with each set of the one or more sets of measurement objects.

In some aspects, the inference configuration comprises an indication of a first measurement report configuration of the one or more measurement report configurations.

In some aspects, the configuration information comprises a network side additional condition associated with a first measurement object of the one or more measurement objects.

In some aspects, method 1100 further includes obtaining signaling that activates, deactivates, or reconfigures the inference configuration.

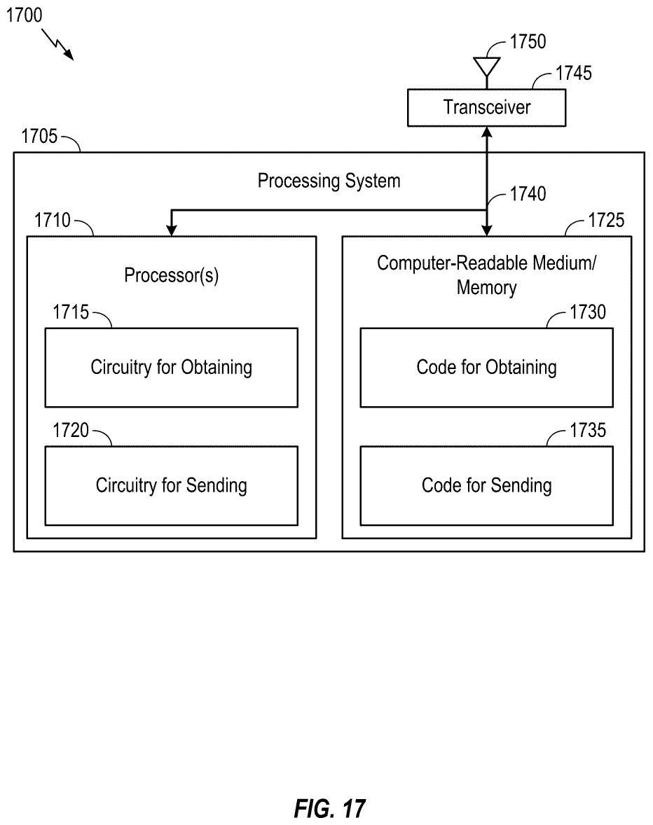

In some aspects, method 1100, or any aspect related to it, may be performed by an apparatus, such as communications device 1700 of FIG. 17, which includes various components operable, configured, or adapted to perform the method 1100. Communications device 1700 is described below in further detail.

Note that FIG. 11 is just one example of a method, and other methods including fewer, additional, or alternative operations are possible consistent with this disclosure.

### Example Operations of a Network Entity

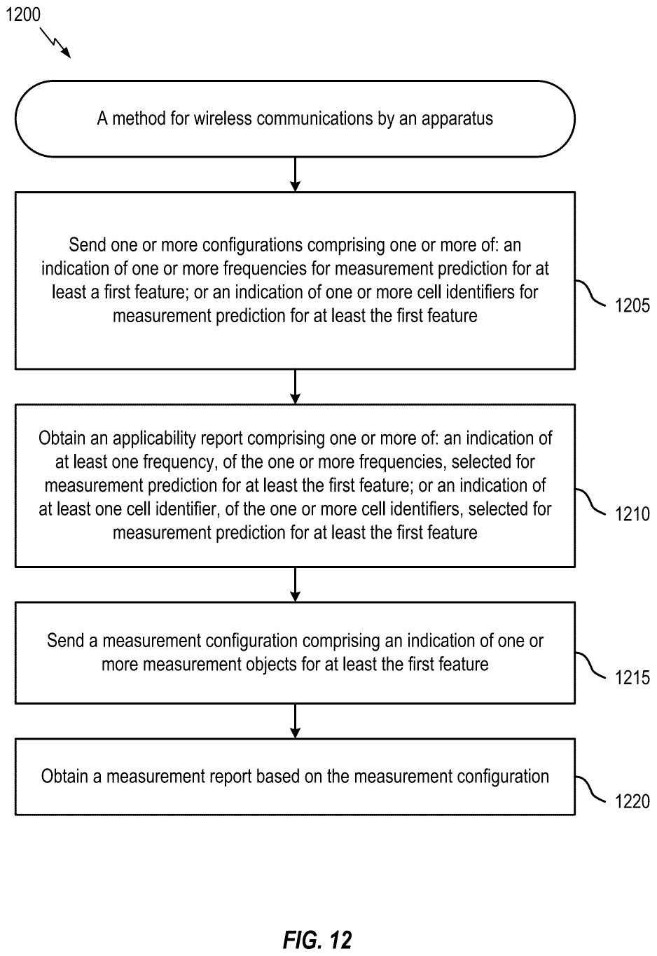

FIG. 12 shows a method 1200 for wireless communications by an apparatus, such as BS 102 of FIG. 1, a first network entity 300 or second network entity 302 of FIG. 3, network entity 502 of FIG. 5, network entity 702 of FIG. 7, network entity 802 of FIG. 8, or a disaggregated base station as discussed with respect to FIG. 2.

Method 1200 begins at block 1205 with sending one or more configurations comprising one or more of: an indication of one or more frequencies for measurement prediction for at least a first feature; or an indication of one or more cell identifiers for measurement prediction for at least the first feature.

Method 1200 then proceeds to block 1210 with obtaining an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature.

Method 1200 then proceeds to block 1215 with sending a measurement configuration comprising an indication of one or more measurement objects for at least the first feature.

Method 1200 then proceeds to block 1220 with obtaining a measurement report based on the measurement configuration.

In some aspects, the first feature comprises one of radio resource management prediction, event prediction, handover failure prediction, or radio link failure prediction.

In some aspects, the one or more configurations further comprise one or more of: an indication of one or more second frequencies for measurement prediction for at least a second feature; or an indication of one or more second cell identifiers for measurement prediction for at least the second feature; and the applicability report further comprises one or more of: an indication of at least one second frequency, of the one or more second frequencies, selected for measurement prediction for at least the second feature; or an indication of at least one second cell identifier, of the one or more second cell identifiers, selected for measurement prediction for at least the second feature.

In some aspects, the measurement configuration further comprises an indication of a measurement report configuration.

In some aspects, the measurement report configuration indicates one or more of: a reporting periodicity; a trigger for reporting; or a quantity of measurements for reporting.

In some aspects, the one or more measurement objects comprise one or more first measurement objects to measure and one or more second measurement objects to predict.

In certain aspects, method 1200 further includes sending signaling that activates, deactivates, or reconfigures the measurement configuration.

In certain aspects, method 1200 further includes sending a neighbor cell list.

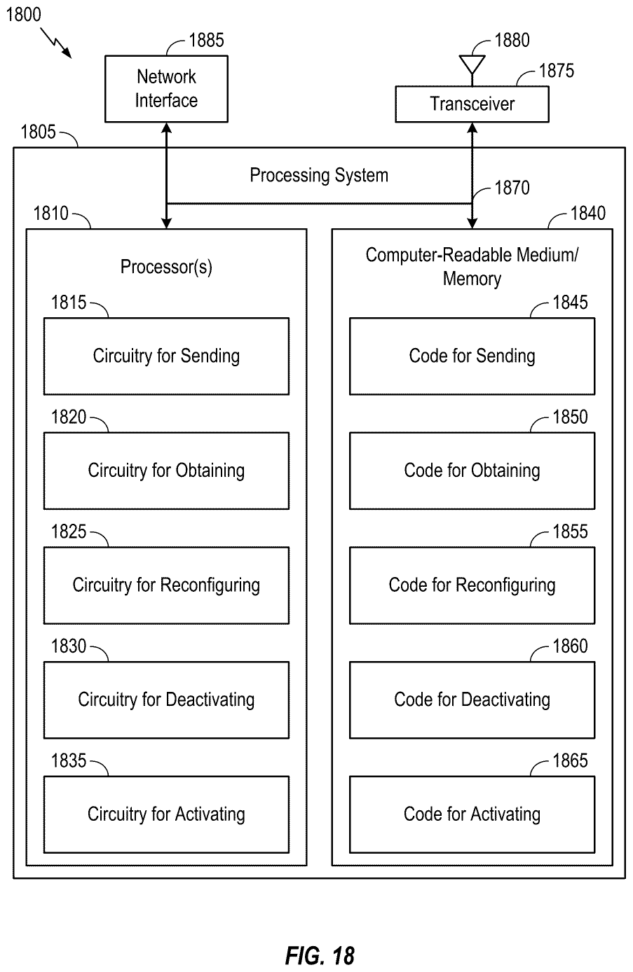

In some aspects, method 1200, or any aspect related to it, may be performed by an apparatus, such as communications device 1800 of FIG. 18, which includes various components operable, configured, or adapted to perform the method 1200. Communications device 1800 is described below in further detail.

Note that FIG. 12 is just one example of a method, and other methods including fewer, additional, or alternative operations are possible consistent with this disclosure.

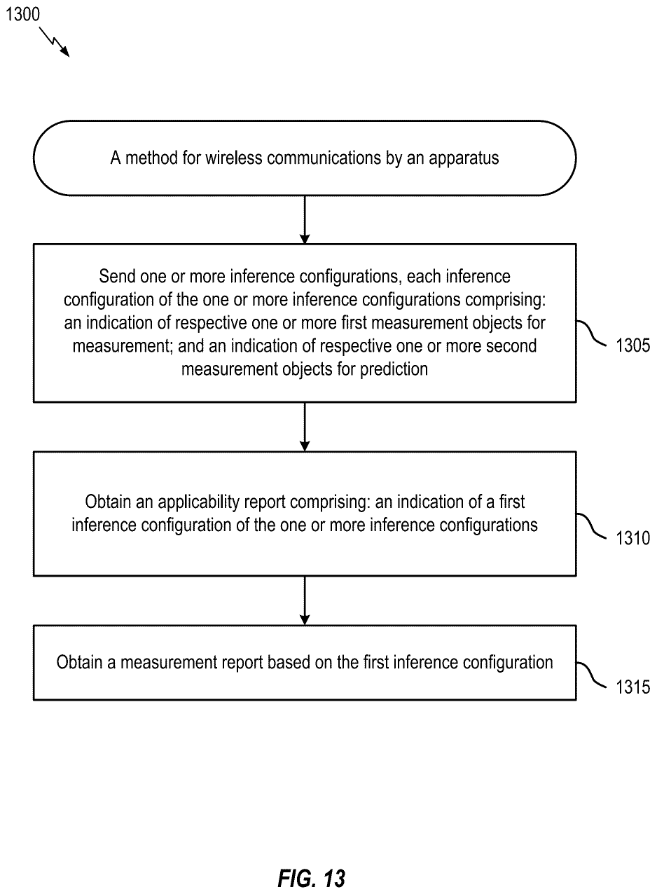

FIG. 13 shows a method 1300 for wireless communications by an apparatus, such as BS 102 of FIG. 1, a first network entity 300 or second network entity 302 of FIG. 3, network entity 502 of FIG. 5, network entity 702 of FIG. 7, network entity 802 of FIG. 8, or a disaggregated base station as discussed with respect to FIG. 2.

Method 1300 begins at block 1305 with sending one or more inference configurations, each inference configuration of the one or more inference configurations comprising: an indication of respective one or more first measurement objects for measurement; and an indication of respective one or more second measurement objects for prediction.

Method 1300 then proceeds to block 1310 with obtaining an applicability report comprising: an indication of a first inference configuration of the one or more inference configurations.

Method 1300 then proceeds to block 1315 with obtaining a measurement report based on the first inference configuration.

In some aspects, each inference configuration of the one or more inference configurations comprises a respective inference configuration identifier; and the indication of the first inference configuration comprises a first inference configuration identifier of the first inference configuration.

In some aspects, each inference configuration of the one or more inference configurations comprises a respective one or more measurement report configurations.

In some aspects, each measurement report configuration of the respective one or more measurement report configurations comprises: a respective reporting periodicity; a respective trigger for reporting; or a respective quantity of measurements for reporting.

In some aspects, the first inference configuration comprises a network side additional condition associated with a first measurement object of the respective one or more first measurement objects or a second measurement object of the respective one or more second measurement objects.

In certain aspects, method 1300 further includes sending signaling that activates, deactivates, or reconfigures the first inference configuration.

In some aspects, the first inference configuration is associated with a first feature; and a second inference configuration of the one or more inference configurations is associated with a second feature.

In some aspects, the first feature comprises one of radio resource management prediction, event prediction, handover failure prediction, or radio link failure prediction.

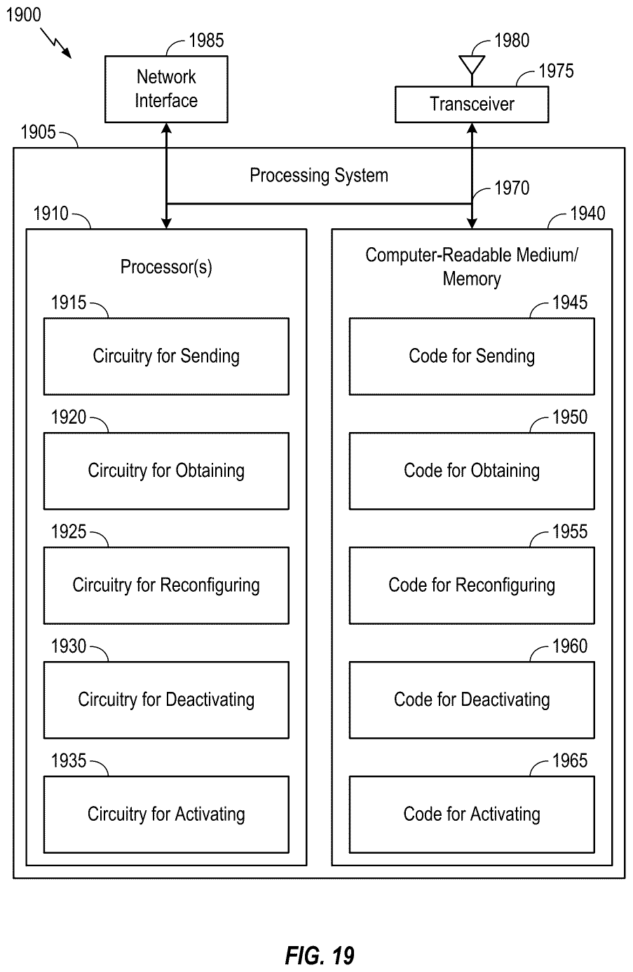

In some aspects, method 1300, or any aspect related to it, may be performed by an apparatus, such as communications device 1900 of FIG. 19, which includes various components operable, configured, or adapted to perform the method 1300. Communications device 1900 is described below in further detail.

Note that FIG. 13 is just one example of a method, and other methods including fewer, additional, or alternative operations are possible consistent with this disclosure.

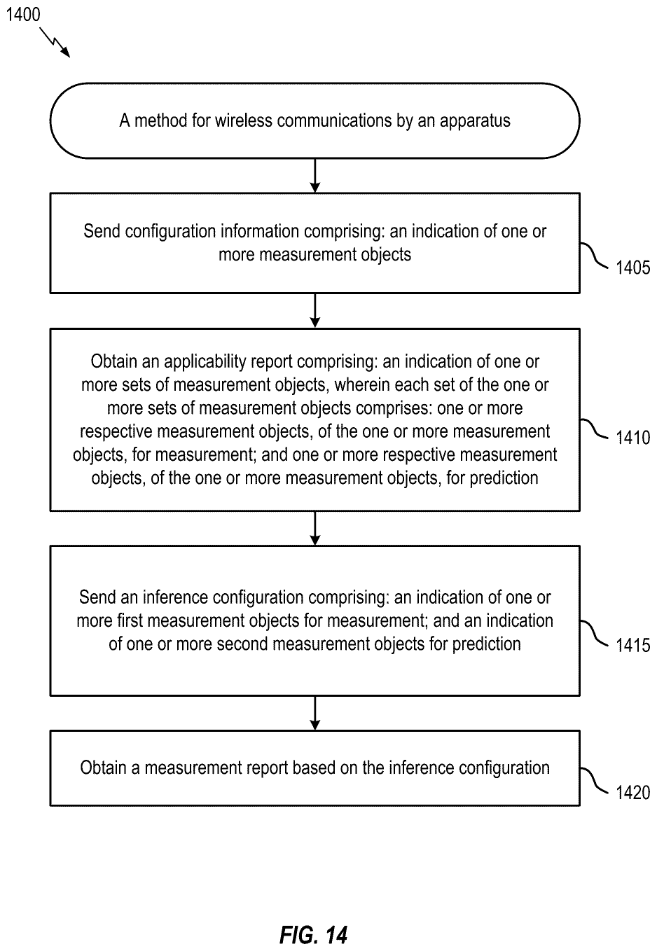

FIG. 14 shows a method 1400 for wireless communications by an apparatus, such as BS 102 of FIG. 1, a first network entity 300 or second network entity 302 of FIG. 3, network entity 502 of FIG. 5, network entity 702 of FIG. 7, network entity 802 of FIG. 8, or a disaggregated base station as discussed with respect to FIG. 2.

Method 1400 begins at block 1405 with sending configuration information comprising: an indication of one or more measurement objects.

Method 1400 then proceeds to block 1410 with obtaining an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction.

Method 1400 then proceeds to block 1415 with sending an inference configuration comprising: an indication of one or more first measurement objects for measurement; and an indication of one or more second measurement objects for prediction.

Method 1400 then proceeds to block 1420 with obtaining a measurement report based on the inference configuration.

In some aspects, the one or more measurement objects comprise: at least one measurement object for measurement; and at least one measurement object for prediction; the one or more respective measurement objects for measurement are selected form the at least one measurement object for measurement; and the one or more respective measurement objects for prediction are selected form the at least one measurement object for prediction.

In some aspects, the configuration information further comprises one or more measurement report configurations.

In some aspects, each measurement report configuration of the one or more measurement report configurations comprises: a respective reporting periodicity; a respective trigger for reporting; or a respective quantity of measurements for reporting.

In some aspects, the applicability report further comprises an indication of one or more respective measurement report configurations, of the one or more measurement report configurations, associated with each set of the one or more sets of measurement objects.

In some aspects, the inference configuration comprises an indication of a first measurement report configuration of the one or more measurement report configurations.

In some aspects, the configuration information comprises a network side additional condition associated with a first measurement object of the one or more measurement objects.

In certain aspects, method 1400 further includes sending signaling that activates, deactivates, or reconfigures the inference configuration.

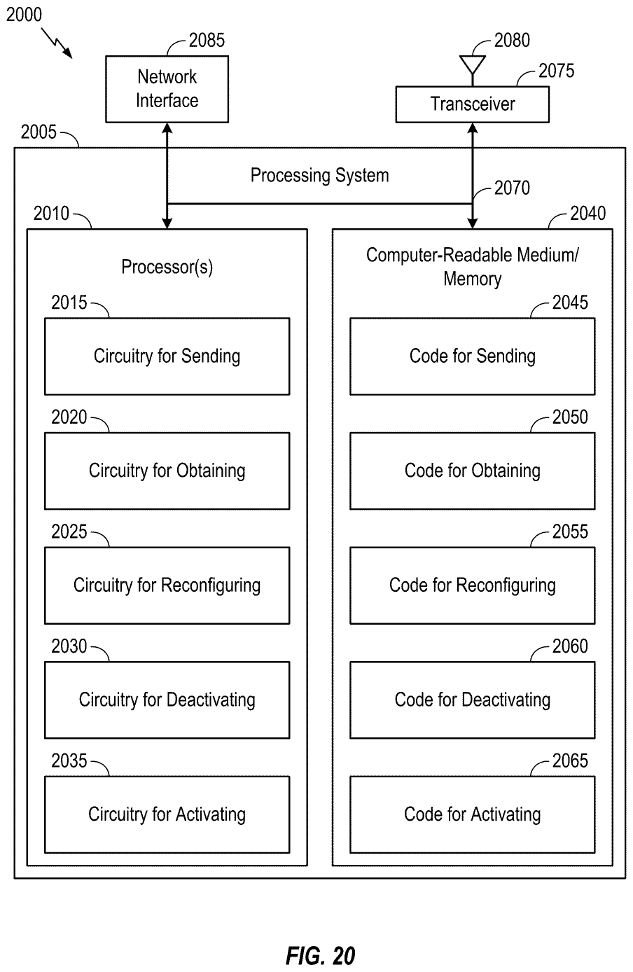

In some aspects, method 1400, or any aspect related to it, may be performed by an apparatus, such as communications device 2000 of FIG. 20, which includes various components operable, configured, or adapted to perform the method 1400. Communications device 2000 is described below in further detail.

Note that FIG. 14 is just one example of a method, and other methods including fewer, additional, or alternative operations are possible consistent with this disclosure.

### Example Communications Devices

FIG. 15 depicts aspects of an example communications device 1500 configured for wireless communications. In some aspects, communications device 1500 is a user equipment, such as UE 104 of FIG. 1, UE 304 of FIG. 3, UE 504 of FIG. 5, UE 704 of FIG. 7, or UE 804 of FIG. 8.

The communications device 1500 includes a processing system 1505 coupled to a transceiver 1585 (e.g., a transmitter and/or a receiver). The transceiver 1585 is configured to transmit and receive signals for the communications device 1500 via an antenna 1590, such as the various signals as described herein. The processing system 1505 may be configured to perform processing functions for the communications device 1500, including processing signals received and/or to be transmitted by the communications device 1500.

The processing system 1505 includes one or more processors 1510 and a computer-readable medium/memory 1545. In various aspects, the one or more processors 1510 may be representative of the one or more processors 318 described with respect to FIG. 3. The one or more processors 1510 are coupled to a computer-readable medium/memory 1545 via a bus 1580. In some aspects, the computer-readable medium/memory 1545 may be representative of the one or more memories 320 described with respect to FIG. 3. The computer-readable medium/memory 1545 is a non-transitory computer-readable medium/memory. In certain aspects, the computer-readable medium/memory 1545 is configured to store instructions (e.g., computer-executable code), that when executed by the one or more processors 1510, cause the one or more processors 1510 to perform the method 900 described with respect to FIG. 9, or any aspect related to it, including any operations described in relation to FIG. 9. Note that reference to a processor performing a function of communications device 1500 may include one or more processors performing that function of communications device 1500, such as in a distributed fashion.

In the depicted example, computer-readable medium/memory 1545 stores code (e.g., executable instructions), including code for obtaining 1550, code for sending 1555, code for reconfiguring 1560, code for deactivating 1565, code for activating 1570, and code for selecting 1575. Processing of the code 1550-1575 may enable and cause the communications device 1500 to perform the method 900 described with respect to FIG. 9, or any aspect related to it. For instance, in some aspects, code for obtaining 1550 includes code for obtaining one or more configurations comprising one or more of: an indication of one or more frequencies for measurement prediction for at least a first feature; or an indication of one or more cell identifiers for measurement prediction for at least the first feature. In some aspects, code for sending 1555 includes code for sending an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature. In some aspects, code for obtaining 1550 includes code for obtaining a measurement configuration comprising an indication of one or more measurement objects for at least the first feature. In some aspects, code for sending 1555 includes code for sending a measurement report based on the measurement configuration.

The one or more processors 1510 include circuitry configured to implement (e.g., execute) the code stored in the computer-readable medium/memory 1545, including circuitry for obtaining 1515, circuitry for sending 1520, circuitry for reconfiguring 1525, circuitry for deactivating 1530, circuitry for activating 1535, and circuitry for selecting 1540. Processing with circuitry 1515-1540 may enable and cause the communications device 1500 to perform the method 900 described with respect to FIG. 9, or any aspect related to it. For instance, in some aspects, circuitry for obtaining 1515 includes circuitry for obtaining one or more configurations comprising one or more of: an indication of one or more frequencies for measurement prediction for at least a first feature; or an indication of one or more cell identifiers for measurement prediction for at least the first feature. In some aspects, circuitry for sending 1520 includes circuitry for sending an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature. In some aspects, circuitry for obtaining 1515 includes circuitry for obtaining a measurement configuration comprising an indication of one or more measurement objects for at least the first feature. In some aspects, circuitry for sending 1520 includes circuitry for sending a measurement report based on the measurement configuration.

More generally, means for communicating, transmitting, sending or outputting for transmission may include the one or more transceivers 324, one or more antenna 322 and/or processing system 316 of the UE 304 illustrated in FIG. 3, transceiver 1585 and/or antenna 1590 of the communications device 1500 in FIG. 15, and/or one or more processors 1510 of the communications device 1500 in FIG. 15. Means for communicating, receiving or obtaining may include the one or more transceivers 324, one or more antennas 322, and/or processing system 316 of the UE 304 illustrated in FIG. 3, transceiver 1585 and/or antenna 1590 of the communications device 1500 in FIG. 15, and/or one or more processors 1510 of the communications device 1500 in FIG. 15.

FIG. 16 depicts aspects of an example communications device 1600 configured for wireless communications. In some aspects, communications device 1600 is a user equipment, such as UE 104 of FIG. 1, UE 304 of FIG. 3, UE 504 of FIG. 5, UE 704 of FIG. 7, or UE 804 of FIG. 8.

The communications device 1600 includes a processing system 1605 coupled to a transceiver 1675 (e.g., a transmitter and/or a receiver). The transceiver 1675 is configured to transmit and receive signals for the communications device 1600 via an antenna 1680, such as the various signals as described herein. The processing system 1605 may be configured to perform processing functions for the communications device 1600, including processing signals received and/or to be transmitted by the communications device 1600.

The processing system 1605 includes one or more processors 1610 and a computer-readable medium/memory 1640. In various aspects, the one or more processors 1610 may be representative of the one or more processors 318 described with respect to FIG. 3. The one or more processors 1610 are coupled to a computer-readable medium/memory 1640 via a bus 1670. In some aspects, the computer-readable medium/memory 1640 may be representative of the one or more memories 320 described with respect to FIG. 3. The computer-readable medium/memory 1640 is a non-transitory computer-readable medium/memory. In certain aspects, the computer-readable medium/memory 1640 is configured to store instructions (e.g., computer-executable code), that when executed by the one or more processors 1610, cause the one or more processors 1610 to perform the method 1000 described with respect to FIG. 10, or any aspect related to it, including any operations described in relation to FIG. 10. Note that reference to a processor performing a function of communications device 1600 may include one or more processors performing that function of communications device 1600, such as in a distributed fashion.

In the depicted example, computer-readable medium/memory 1640 stores code (e.g., executable instructions), including code for obtaining 1645, code for sending 1650, code for reconfiguring 1655, code for deactivating 1660, and code for activating 1665. Processing of the code 1645-1665 may enable and cause the communications device 1600 to perform the method 1000 described with respect to FIG. 10, or any aspect related to it. For instance, in some aspects, code for obtaining 1645 includes code for obtaining one or more inference configurations, each inference configuration of the one or more inference configurations comprising: an indication of respective one or more first measurement objects for measurement; and an indication of respective one or more second measurement objects for prediction. In some aspects, code for sending 1650 includes code for sending an applicability report comprising: an indication of a first inference configuration of the one or more inference configurations. In some aspects, code for sending 1650 includes code for sending a measurement report based on the first inference configuration.

The one or more processors 1610 include circuitry configured to implement (e.g., execute) the code stored in the computer-readable medium/memory 1640, including circuitry for obtaining 1615, circuitry for sending 1620, circuitry for reconfiguring 1625, circuitry for deactivating 1630, and circuitry for activating 1635. Processing with circuitry 1615-1635 may enable and cause the communications device 1600 to perform the method 1000 described with respect to FIG. 10, or any aspect related to it. For instance, in some aspects, circuitry for obtaining 1615 includes circuitry for obtaining one or more inference configurations, each inference configuration of the one or more inference configurations comprising: an indication of respective one or more first measurement objects for measurement; and an indication of respective one or more second measurement objects for prediction. In some aspects, circuitry for sending 1620 includes circuitry for sending an applicability report comprising: an indication of a first inference configuration of the one or more inference configurations. In some aspects, circuitry for sending 1620 includes circuitry for sending a measurement report based on the first inference configuration.

More generally, means for communicating, transmitting, sending or outputting for transmission may include the one or more transceivers 324, one or more antenna 322 and/or processing system 316 of the UE 304 illustrated in FIG. 3, transceiver 1675 and/or antenna 1680 of the communications device 1600 in FIG. 16, and/or one or more processors 1610 of the communications device 1600 in FIG. 16. Means for communicating, receiving or obtaining may include the one or more transceivers 324, one or more antennas 322, and/or processing system 316 of the UE 304 illustrated in FIG. 3, transceiver 1675 and/or antenna 1680 of the communications device 1600 in FIG. 16, and/or one or more processors 1610 of the communications device 1600 in FIG. 16.

FIG. 17 depicts aspects of an example communications device 1700 configured for wireless communications. In some aspects, communications device 1700 is a user equipment, such as UE 104 of FIG. 1, UE 304 of FIG. 3, UE 504 of FIG. 5, UE 704 of FIG. 7, or UE 804 of FIG. 8.

The communications device 1700 includes a processing system 1705 coupled to a transceiver 1745 (e.g., a transmitter and/or a receiver). The transceiver 1745 is configured to transmit and receive signals for the communications device 1700 via an antenna 1750, such as the various signals as described herein. The processing system 1705 may be configured to perform processing functions for the communications device 1700, including processing signals received and/or to be transmitted by the communications device 1700.

The processing system 1705 includes one or more processors 1710 and a computer-readable medium/memory 1725. In various aspects, the one or more processors 1710 may be representative of the one or more processors 318 described with respect to FIG. 3. The one or more processors 1710 are coupled to a computer-readable medium/memory 1725 via a bus 1740. In some aspects, the computer-readable medium/memory 1725 may be representative of the one or more memories 320 described with respect to FIG. 3. The computer-readable medium/memory 1725 is a non-transitory computer-readable medium/memory. In certain aspects, the computer-readable medium/memory 1725 is configured to store instructions (e.g., computer-executable code), that when executed by the one or more processors 1710, cause the one or more processors 1710 to perform the method 1100 described with respect to FIG. 11, or any aspect related to it, including any operations described in relation to FIG. 11. Note that reference to a processor performing a function of communications device 1700 may include one or more processors performing that function of communications device 1700, such as in a distributed fashion.

In the depicted example, computer-readable medium/memory 1725 stores code (e.g., executable instructions), including code for obtaining 1730 and code for sending 1735. Processing of the code 1730 and 1735 may enable and cause the communications device 1700 to perform the method 1100 described with respect to FIG. 11, or any aspect related to it. For instance, in some aspects, code for obtaining 1730 includes code for obtaining configuration information comprising: an indication of one or more measurement objects. In some aspects, code for sending 1735 includes code for sending an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction. In some aspects, code for obtaining 1730 includes code for obtaining an inference configuration comprising: an indication of one or more first measurement objects for measurement; and an indication of one or more second measurement objects for prediction. In some aspects, code for sending 1735 includes code for sending a measurement report based on the inference configuration.

The one or more processors 1710 include circuitry configured to implement (e.g., execute) the code stored in the computer-readable medium/memory 1725, including circuitry for obtaining 1715 and circuitry for sending 1720. Processing with circuitry 1715 and 1720 may enable and cause the communications device 1700 to perform the method 1100 described with respect to FIG. 11, or any aspect related to it. For instance, in some aspects, circuitry for obtaining 1715 includes circuitry for obtaining inference configuration information comprising: an indication of one or more measurement objects. In some aspects, circuitry for sending 1720 includes circuitry for sending an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction. In some aspects, circuitry for obtaining 1715 includes circuitry for obtaining an inference configuration comprising: an indication of one or more first measurement objects for measurement; and an indication of one or more second measurement objects for prediction. In some aspects, circuitry for sending 1720 includes circuitry for sending a measurement report based on the inference configuration.

More generally, means for communicating, transmitting, sending or outputting for transmission may include the one or more transceivers 324, one or more antenna 322 and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17. Means for communicating, receiving or obtaining may include the one or more transceivers 324, one or more antennas 322, and/or processing system 316 of the UE 304 illustrated in FIG. 3, transceiver 1745 and/or antenna 1750 of the communications device 1700 in FIG. 17, and/or one or more processors 1710 of the communications device 1700 in FIG. 17.

FIG. 18 depicts aspects of an example communications device configured for wireless communications. In some aspects, communications device 1800 is a network entity, such as BS 102 of FIG. 1, a first network entity 300 or second network entity 302 of FIG. 3, network entity 502 of FIG. 5, network entity 702 of FIG. 7, network entity 802 of FIG. 8, or a disaggregated base station as discussed with respect to FIG. 2.

The communications device 1800 includes a processing system 1805 coupled to a transceiver 1875 (e.g., a transmitter and/or a receiver) and/or a network interface 1885. The transceiver 1875 is configured to transmit and receive signals for the communications device 1800 via an antenna 1880, such as the various signals as described herein. The network interface 1885 is configured to obtain and send signals for the communications device 1800 via communications link(s), such as a backhaul link, midhaul link, and/or fronthaul link as described herein, such as with respect to FIG. 2. The processing system 1805 may be configured to perform processing functions for the communications device 1800, including processing signals received and/or to be transmitted by the communications device 1800.

The processing system 1805 includes one or more processors 1810 and a computer-readable medium/memory 1840. In various aspects, one or more processors 1810 may be representative of the one or more processors 308, as described with respect to FIG. 3. The one or more processors 1810 are coupled to the computer-readable medium/memory 1840 via a bus 1870. In certain aspects, the computer-readable medium/memory 1840 is configured to store instructions (e.g., computer-executable code), including code 1845-1865, that when executed by the one or more processors 1810, cause the one or more processors 1810 to perform the method 1200 described with respect to FIG. 12, or any aspect related to it, including any operations described in relation to FIG. 12. The computer-readable medium/memory 1840 is a non-transitory computer-readable medium/memory. Note that reference to a processor of communications device 1800 performing a function may include one or more processors of communications device 1800 performing that function, such as in a distributed fashion.

In the depicted example, the computer-readable medium/memory 1840 stores code (e.g., executable instructions), including code for sending 1845, code for obtaining 1850, code for reconfiguring 1855, code for deactivating 1860, and code for activating 1865. Processing of the code 1845-1865 may enable and cause the communications device 1800 to perform the method 1200 described with respect to FIG. 12, or any aspect related to it. For instance, in some aspects, code for sending 1845 includes code for sending one or more configurations comprising one or more of: an indication of one or more frequencies for measurement prediction for at least a first feature; or an indication of one or more cell identifiers for measurement prediction for at least the first feature. In some aspects, code for obtaining 1850 includes code for obtaining an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature. In some aspects, code for sending 1845 includes code for sending a measurement configuration comprising an indication of one or more measurement objects for at least the first feature. In some aspects, code for obtaining 1850 includes code for obtaining a measurement report based on the measurement configuration.

The one or more processors 1810 include circuitry configured to implement (e.g., execute) the code stored in the computer-readable medium/memory 1840, including circuitry for sending 1815, circuitry for obtaining 1820, circuitry for reconfiguring 1825, circuitry for deactivating 1830, and circuitry for activating 1835. Processing with circuitry 1815-1835 may enable and cause the communications device 1800 to perform the method 1200 described with respect to FIG. 12, or any aspect related to it. For instance, in some aspects, circuitry for sending 1815 includes circuitry for sending one or more configurations comprising one or more of: an indication of one or more frequencies for measurement prediction for at least a first feature; or an indication of one or more cell identifiers for measurement prediction for at least the first feature. In some aspects, circuitry for obtaining 1820 includes circuitry for obtaining an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature. In some aspects, circuitry for sending 1815 includes circuitry for sending a measurement configuration comprising an indication of one or more measurement objects for at least the first feature. In some aspects, circuitry for obtaining 1820 includes circuitry for obtaining a measurement report based on the measurement configuration.

Various components of the communications device 1800 may provide means for performing the method 1200 described with respect to FIG. 12, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1875, antenna 1880, and/or network interface 1885 of the communications device 1800 in FIG. 18, and/or one or more processors 1810 of the communications device 1800 in FIG. 18. Means for communicating, receiving or obtaining may include the one or more transceivers 312, one or more antennas 314, and/or processing system 306 of the first network entity 300 or the second network entity 302 illustrated in FIG. 3, transceiver 1875, antenna 1880, and/or network interface 1885 of the communications device 1800 in FIG. 18, and/or one or more processors 1810 of the communications device 1800 in FIG. 18.

FIG. 19 depicts aspects of an example communications device configured for wireless communications. In some aspects, communications device 1900 is a network entity, such as BS 102 of FIG. 1, a first network entity 300 or second network entity 302 of FIG. 3, network entity 502 of FIG. 5, network entity 702 of FIG. 7, network entity 802 of FIG. 8, or a disaggregated base station as discussed with respect to FIG. 2.

The communications device 1900 includes a processing system 1905 coupled to a transceiver 1975 (e.g., a transmitter and/or a receiver) and/or a network interface 1985. The transceiver 1975 is configured to transmit and receive signals for the communications device 1900 via an antenna 1980, such as the various signals as described herein. The network interface 1985 is configured to obtain and send signals for the communications device 1900 via communications link(s), such as a backhaul link, midhaul link, and/or fronthaul link as described herein, such as with respect to FIG. 2. The processing system 1905 may be configured to perform processing functions for the communications device 1900, including processing signals received and/or to be transmitted by the communications device 1900.

The processing system 1905 includes one or more processors 1910 and a computer-readable medium/memory 1940. In various aspects, one or more processors 1910 may be representative of the one or more processors 308, as described with respect to FIG. 3. The one or more processors 1910 are coupled to the computer-readable medium/memory 1940 via a bus 1970. In certain aspects, the computer-readable medium/memory 1940 is configured to store instructions (e.g., computer-executable code), including code 1945-1965, that when executed by the one or more processors 1910, cause the one or more processors 1910 to perform the method 1300 described with respect to FIG. 13, or any aspect related to it, including any operations described in relation to FIG. 13. The computer-readable medium/memory 1940 is a non-transitory computer-readable medium/memory. Note that reference to a processor of communications device 1900 performing a function may include one or more processors of communications device 1900 performing that function, such as in a distributed fashion.

In the depicted example, the computer-readable medium/memory 1940 stores code (e.g., executable instructions), including code for sending 1945, code for obtaining 1950, code for reconfiguring 1955, code for deactivating 1960, and code for activating 1965. Processing of the code 1945-1965 may enable and cause the communications device 1900 to perform the method 1300 described with respect to FIG. 13, or any aspect related to it. For instance, in some aspects, code for sending 1945 includes code for sending one or more inference configurations, each inference configuration of the one or more inference configurations comprising: an indication of respective one or more first measurement objects for measurement; and an indication of respective one or more second measurement objects for prediction. In some aspects, code for obtaining 1950 includes code for obtaining an applicability report comprising: an indication of a first inference configuration of the one or more inference configurations. In some aspects, code for obtaining 1950 includes code for obtaining a measurement report based on the first inference configuration.

The one or more processors 1910 include circuitry configured to implement (e.g., execute) the code stored in the computer-readable medium/memory 1940, including circuitry for sending 1915, circuitry for obtaining 1920, circuitry for reconfiguring 1925, circuitry for deactivating 1930, and circuitry for activating 1935. Processing with circuitry 1915-1935 may enable and cause the communications device 1900 to perform the method 1300 described with respect to FIG. 13, or any aspect related to it. For instance, in some aspects, circuitry for sending 1915 includes circuitry for sending one or more inference configurations, each inference configuration of the one or more inference configurations comprising: an indication of respective one or more first measurement objects for measurement; and an indication of respective one or more second measurement objects for prediction. In some aspects, circuitry for obtaining 1920 includes circuitry for obtaining an applicability report comprising: an indication of a first inference configuration of the one or more inference configurations. In some aspects, circuitry for obtaining 1920 includes circuitry for obtaining a measurement report based on the first inference configuration.

Various components of the communications device 1900 may provide means for performing the method 1300 described with respect to FIG. 13, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1975, antenna 1980, and/or network interface 1985 of the communications device 1900 in FIG. 19, and/or one or more processors 1910 of the communications device 1900 in FIG. 19. Means for communicating, receiving or obtaining may include the one or more transceivers 312, one or more antennas 314, and/or processing system 306 of the first network entity 300 or the second network entity 302 illustrated in FIG. 3, transceiver 1975, antenna 1980, and/or network interface 1985 of the communications device 1900 in FIG. 19, and/or one or more processors 1910 of the communications device 1900 in FIG. 19.

FIG. 20 depicts aspects of an example communications device configured for wireless communications. In some aspects, communications device 2000 is a network entity, such as BS 102 of FIG. 1, a first network entity 300 or second network entity 302 of FIG. 3, network entity 502 of FIG. 5, network entity 702 of FIG. 7, network entity 802 of FIG. 8, or a disaggregated base station as discussed with respect to FIG. 2.

The communications device 2000 includes a processing system 2005 coupled to a transceiver 2075 (e.g., a transmitter and/or a receiver) and/or a network interface 2085. The transceiver 2075 is configured to transmit and receive signals for the communications device 2000 via an antenna 2080, such as the various signals as described herein. The network interface 2085 is configured to obtain and send signals for the communications device 2000 via communications link(s), such as a backhaul link, midhaul link, and/or fronthaul link as described herein, such as with respect to FIG. 2. The processing system 2005 may be configured to perform processing functions for the communications device 2000, including processing signals received and/or to be transmitted by the communications device 2000.

The processing system 2005 includes one or more processors 2010 and a computer-readable medium/memory 2040. In various aspects, one or more processors 2010 may be representative of the one or more processors 308, as described with respect to FIG. 3. The one or more processors 2010 are coupled to the computer-readable medium/memory 2040 via a bus 2070. In certain aspects, the computer-readable medium/memory 2040 is configured to store instructions (e.g., computer-executable code), including code 2045-2065, that when executed by the one or more processors 2010, cause the one or more processors 2010 to perform the method 1400 described with respect to FIG. 14, or any aspect related to it, including any operations described in relation to FIG. 14. The computer-readable medium/memory 2040 is a non-transitory computer-readable medium/memory. Note that reference to a processor of communications device 2000 performing a function may include one or more processors of communications device 2000 performing that function, such as in a distributed fashion.

In the depicted example, the computer-readable medium/memory 2040 stores code (e.g., executable instructions), including code for sending 2045, code for obtaining 2050, code for reconfiguring 2055, code for deactivating 2060, and code for activating 2065. Processing of the code 2045-2065 may enable and cause the communications device 2000 to perform the method 1400 described with respect to FIG. 14, or any aspect related to it. For instance, in some aspects, code for sending 2045 includes code for sending configuration information comprising: an indication of one or more measurement objects. In some aspects, code for obtaining 2050 includes code for obtaining an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction. In some aspects, code for sending 2045 includes code for sending an inference configuration comprising: an indication of one or more first measurement objects for measurement; and an indication of one or more second measurement objects for prediction. In some aspects, code for obtaining 2050 includes code for obtaining a measurement report based on the inference configuration.

The one or more processors 2010 include circuitry configured to implement (e.g., execute) the code stored in the computer-readable medium/memory 2040, including circuitry for sending 2015, circuitry for obtaining 2020, circuitry for reconfiguring 2025, circuitry for deactivating 2030, and circuitry for activating 2035. Processing with circuitry 2015-2035 may enable and cause the communications device 2000 to perform the method 1400 described with respect to FIG. 14, or any aspect related to it. For instance, in some aspects, circuitry for sending 2015 includes circuitry for sending configuration information comprising: an indication of one or more measurement objects. In some aspects, circuitry for obtaining 2020 includes circuitry for obtaining an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction. In some aspects, circuitry for sending 2015 includes circuitry for sending an inference configuration comprising: an indication of one or more first measurement objects for measurement; and an indication of one or more second measurement objects for prediction. In some aspects, circuitry for obtaining 2020 includes circuitry for obtaining a measurement report based on the inference configuration.

Various components of the communications device 2000 may provide means for performing the method 1400 described with respect to FIG. 14, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 2075, antenna 2080, and/or network interface 2085 of the communications device 2000 in FIG. 20, and/or one or more processors 2010 of the communications device 2000 in FIG. 20. Means for communicating, receiving or obtaining may include the one or more transceivers 312, one or more antennas 314, and/or processing system 306 of the first network entity 300 or the second network entity 302 illustrated in FIG. 3, transceiver 2075, antenna 2080, and/or network interface 2085 of the communications device 2000 in FIG. 20, and/or one or more processors 2010 of the communications device 2000 in FIG. 20.

### Example Clauses

Implementation examples are described in the following numbered clauses:
Clause 1: A method for wireless communications by an apparatus comprising: obtaining one or more configurations comprising one or more of: an indication of one or more frequencies for measurement prediction for at least a first feature; or an indication of one or more cell identifiers for measurement prediction for at least the first feature; sending an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; obtaining a measurement configuration comprising an indication of one or more measurement objects for at least the first feature; and sending a measurement report based on the measurement configuration.
Clause 2: The method of Clause 1, wherein the first feature comprises one of radio resource management prediction, event prediction, handover failure prediction, or radio link failure prediction.
Clause 3: The method of any one of Clauses 1-2, wherein: the one or more configurations further comprise one or more of: an indication of one or more second frequencies for measurement prediction for at least a second feature; or an indication of one or more second cell identifiers for measurement prediction for at least the second feature; and the applicability report further comprises one or more of: an indication of at least one second frequency, of the one or more second frequencies, selected for measurement prediction for at least the second feature; or an indication of at least one second cell identifier, of the one or more second cell identifiers, selected for measurement prediction for at least the second feature.
Clause 4: The method of any one of Clauses 1-3, wherein the measurement configuration further comprises an indication of a measurement report configuration.
Clause 5: The method of Clause 4, wherein the measurement report configuration indicates one or more of: a reporting periodicity; a trigger for reporting; or a quantity of measurements for reporting.
Clause 6: The method of any one of Clauses 1-5, wherein the one or more measurement objects comprise one or more first measurement objects to measure and one or more second measurement objects to predict.
Clause 7: The method of any one of Clauses 1-6, further comprising: obtaining signaling that activates, deactivates, or reconfigures the measurement configuration.
Clause 8: The method of any one of Clauses 1-7, further comprising: obtaining a neighbor cell list; and at least one of: selecting the at least one frequency based on the neighbor cell list; or selecting the at least one cell identifier based on the neighbor cell list.
Clause 9: A method for wireless communications by an apparatus comprising: obtaining one or more inference configurations, each inference configuration of the one or more inference configurations comprising: an indication of respective one or more first measurement objects for measurement; and an indication of respective one or more second measurement objects for prediction; sending an applicability report comprising: an indication of a first inference configuration of the one or more inference configurations; and sending a measurement report based on the first inference configuration.
Clause 10: The method of Clause 9, wherein: each inference configuration of the one or more inference configurations comprises a respective inference configuration identifier; and the indication of the first inference configuration comprises a first inference configuration identifier of the first inference configuration.

Clause 11: The method of any one of Clauses 9-10, wherein each inference configuration of the one or more inference configurations comprises a respective one or more measurement report configurations.
Clause 12: The method of Clause 11, wherein each measurement report configuration of the respective one or more measurement report configurations comprises: a respective reporting periodicity; a respective trigger for reporting; or a respective quantity of measurements for reporting.
Clause 13: The method of any one of Clauses 9-12, wherein the first inference configuration comprises a network side additional condition associated with a first measurement object of the respective one or more first measurement objects or a second measurement object of the respective one or more second measurement objects.
Clause 14: The method of any one of Clauses 9-13, further comprising: obtaining signaling that activates, deactivates, or reconfigures the first inference configuration.
Clause 15: The method of any one of Clauses 9-14, wherein: the first inference configuration is associated with a first feature; and a second inference configuration of the one or more inference configurations is associated with a second feature.
Clause 16: The method of Clause 15, wherein the first feature comprises one of radio resource management prediction, event prediction, handover failure prediction, or radio link failure prediction.
Clause 17: A method for wireless communications by an apparatus comprising: obtaining configuration information comprising: an indication of one or more measurement objects; sending an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; obtaining an inference configuration comprising: an indication of one or more first measurement objects for measurement; and an indication of one or more second measurement objects for prediction; and sending a measurement report based on the inference configuration.
Clause 18: The method of Clause 17, wherein: the one or more measurement objects comprise: at least one measurement object for measurement; and at least one measurement object for prediction; the one or more respective measurement objects for measurement are selected form the at least one measurement object for measurement; and the one or more respective measurement objects for prediction are selected form the at least one measurement object for prediction.
Clause 19: The method of any one of Clauses 17-18, wherein the configuration information further comprises one or more measurement report configurations.
Clause 20: The method of Clause 19, wherein each measurement report configuration of the one or more measurement report configurations comprises: a respective reporting periodicity; a respective trigger for reporting; or a respective quantity of measurements for reporting.
Clause 21: The method of Clause 19, wherein the applicability report further comprises an indication of one or more respective measurement report configurations, of the one or more measurement report configurations, associated with each set of the one or more sets of measurement objects.
Clause 22: The method of Clause 19, wherein the inference configuration comprises an indication of a first measurement report configuration of the one or more measurement report configurations.
Clause 23: The method of any one of Clauses 17-22, wherein the configuration information comprises a network side additional condition associated with a first measurement object of the one or more measurement objects.
Clause 24: The method of any one of Clauses 17-23, further comprising: obtaining signaling that activates, deactivates, or reconfigures the inference configuration.
Clause 25: A method for wireless communications by an apparatus comprising: sending one or more configurations comprising one or more of: an indication of one or more frequencies for measurement prediction for at least a first feature; or an indication of one or more cell identifiers for measurement prediction for at least the first feature; obtaining an applicability report comprising one or more of: an indication of at least one frequency, of the one or more frequencies, selected for measurement prediction for at least the first feature; or an indication of at least one cell identifier, of the one or more cell identifiers, selected for measurement prediction for at least the first feature; sending a measurement configuration comprising an indication of one or more measurement objects for at least the first feature; and obtaining a measurement report based on the measurement configuration.
Clause 26: The method of Clause 25, wherein the first feature comprises one of radio resource management prediction, event prediction, handover failure prediction, or radio link failure prediction.
Clause 27: The method of any one of Clauses 25-26, wherein: the one or more configurations further comprise one or more of: an indication of one or more second frequencies for measurement prediction for at least a second feature; or an indication of one or more second cell identifiers for measurement prediction for at least the second feature; and the applicability report further comprises one or more of: an indication of at least one second frequency, of the one or more second frequencies, selected for measurement prediction for at least the second feature; or an indication of at least one second cell identifier, of the one or more second cell identifiers, selected for measurement prediction for at least the second feature.
Clause 28: The method of any one of Clauses 25-27, wherein the measurement configuration further comprises an indication of a measurement report configuration.
Clause 29: The method of Clause 28, wherein the measurement report configuration indicates one or more of: a reporting periodicity; a trigger for reporting; or a quantity of measurements for reporting.
Clause 30: The method of any one of Clauses 25-29, wherein the one or more measurement objects comprise one or more first measurement objects to measure and one or more second measurement objects to predict.
Clause 31: The method of any one of Clauses 25-30, further comprising: sending signaling that activates, deactivates, or reconfigures the measurement configuration.
Clause 32: The method of any one of Clauses 25-31, further comprising sending a neighbor cell list.
Clause 33: A method for wireless communications by an apparatus comprising: sending one or more inference configurations, each inference configuration of the one or more inference configurations comprising: an indication of respective one or more first measurement objects for measurement; and an indication of respective one or more second measurement objects for prediction; obtaining an applicability report comprising: an indication of a first inference configuration of the one or more inference configurations; and obtaining a measurement report based on the first inference configuration.
Clause 34: The method of Clause 33, wherein: each inference configuration of the one or more inference configurations comprises a respective inference configuration identifier; and the indication of the first inference configuration comprises a first inference configuration identifier of the first inference configuration.
Clause 35: The method of any one of Clauses 33-34, wherein each inference configuration of the one or more inference configurations comprises a respective one or more measurement report configurations.
Clause 36: The method of Clause 35, wherein each measurement report configuration of the respective one or more measurement report configurations comprises: a respective reporting periodicity; a respective trigger for reporting; or a respective quantity of measurements for reporting.
Clause 37: The method of any one of Clauses 33-36, wherein the first inference configuration comprises a network side additional condition associated with a first measurement object of the respective one or more first measurement objects or a second measurement object of the respective one or more second measurement objects.
Clause 38: The method of any one of Clauses 33-37, further comprising: sending signaling that activates, deactivates, or reconfigures the first inference configuration.
Clause 39: The method of any one of Clauses 33-38, wherein: the first inference configuration is associated with a first feature; and a second inference configuration of the one or more inference configurations is associated with a second feature.
Clause 40: The method of Clause 39, wherein the first feature comprises one of radio resource management prediction, event prediction, handover failure prediction, or radio link failure prediction.
Clause 41: A method for wireless communications by an apparatus comprising: sending configuration information comprising: an indication of one or more measurement objects; obtaining an applicability report comprising: an indication of one or more sets of measurement objects, wherein each set of the one or more sets of measurement objects comprises: one or more respective measurement objects, of the one or more measurement objects, for measurement; and one or more respective measurement objects, of the one or more measurement objects, for prediction; sending an inference configuration comprising: an indication of one or more first measurement objects for measurement; and an indication of one or more second measurement objects for prediction; and obtaining a measurement report based on the inference configuration.
Clause 42: The method of Clause 41, wherein: the one or more measurement objects comprise: at least one measurement object for measurement; and at least one measurement object for prediction; the one or more respective measurement objects for measurement are selected form the at least one measurement object for measurement; and the one or more respective measurement objects for prediction are selected form the at least one measurement object for prediction.
Clause 43: The method of any one of Clauses 41-42, wherein the configuration information further comprises one or more measurement report configurations.
Clause 44: The method of Clause 43, wherein each measurement report configuration of the one or more measurement report configurations comprises: a respective reporting periodicity; a respective trigger for reporting; or a respective quantity of measurements for reporting.
Clause 45: The method of Clause 43, wherein the applicability report further comprises an indication of one or more respective measurement report configurations, of the one or more measurement report configurations, associated with each set of the one or more sets of measurement objects.
Clause 46: The method of Clause 43, wherein the inference configuration comprises an indication of a first measurement report configuration of the one or more measurement report configurations.
Clause 47: The method of any one of Clauses 41-46, wherein the configuration information comprises a network side additional condition associated with a first measurement object of the one or more measurement objects.
Clause 48: The method of any one of Clauses 41-47, further comprising: sending signaling that activates, deactivates, or reconfigures the inference configuration.
Clause 49: One or more apparatuses, comprising: one or more memories comprising executable instructions; and one or more processors configured to execute the executable instructions and cause the one or more apparatuses to perform a method in accordance with any one of Clauses 1-48.
Clause 50: One or more apparatuses configured for wireless communications, comprising: one or more memories; and one or more processors, coupled to the one or more memories, configured to cause the one or more apparatuses to perform a method in accordance with any one of Clauses 1-48.
Clause 51: One or more apparatuses configured for wireless communications, comprising: one or more memories; and one or more processors, coupled to the one or more memories, configured to perform a method in accordance with any one of Clauses 1-48.
Clause 52: One or more apparatuses, comprising means for performing a method in accordance with any one of Clauses 1-48.

Clause 53: One or more non-transitory computer-readable media comprising executable instructions that, when executed by one or more processors of one or more apparatuses, cause the one or more apparatuses to perform a method in accordance with any one of Clauses 1-48.

Clause 54: One or more computer program products embodied on one or more computer-readable storage media comprising code for performing a method in accordance with any one of Clauses 1-48.

Clause 55: One or more apparatuses configured for wireless communications, comprising: a processing system that includes one or more processors and one or more memories coupled with the one or more processors, the processing system configured to cause the one or more apparatuses to perform a method in accordance with any one of Clauses 1-48.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus comprising a processing system that includes one or more processors and one or more memories coupled with the one or more processors, the processing system configured to cause the apparatus to:
obtain one or more configurations comprising one or more of:
an indication of one or more frequencies for measurement prediction for at least a first feature; or
an indication of one or more cell identifiers for measurement prediction for at least the first feature;
send an applicability report comprising one or more of:
an indication of at least one frequency, of the one or more frequencies, selected for measurement prediction for at least the first feature; or
an indication of at least one cell identifier, of the one or more cell identifiers, selected for measurement prediction for at least the first feature;
obtain a measurement configuration comprising an indication of one or more measurement objects for at least the first feature; and
send a measurement report based on the measurement configuration.

2. The apparatus of claim 1, wherein the first feature comprises one of a radio resource management prediction, an event prediction, a handover failure prediction, or a radio link failure prediction.

3. The apparatus of claim 1, wherein:
the one or more configurations further comprise one or more of:
an indication of one or more second frequencies for measurement prediction for at least a second feature; or
an indication of one or more second cell identifiers for measurement prediction for at least the second feature; and
the applicability report further comprises one or more of:
an indication of at least one second frequency, of the one or more second frequencies, selected for measurement prediction for at least the second feature; or
an indication of at least one second cell identifier, of the one or more second cell identifiers, selected for measurement prediction for at least the second feature.

4. The apparatus of claim 1, wherein the measurement configuration further comprises an indication of a measurement report configuration.

5. The apparatus of claim 4, wherein the measurement report configuration indicates one or more of:
a reporting periodicity;
a trigger for reporting; or
a quantity of measurements for reporting.

6. The apparatus of claim 1, wherein the one or more measurement objects comprise one or more first measurement objects to measure and one or more second measurement objects to predict.

7. The apparatus of claim 1, wherein the processing system is further configured to cause the apparatus to:
obtain signaling that activates, deactivates, or reconfigures the measurement configuration.

8. The apparatus of claim 1, wherein the processing system is further configured to cause the apparatus to:
obtain a neighbor cell list; and
at least one of:
select the at least one frequency based on the neighbor cell list; or
select the at least one cell identifier based on the neighbor cell list.

9. An apparatus comprising a processing system that includes one or more processors and one or more memories coupled with the one or more processors, the processing system configured to cause the apparatus to:
obtain one or more inference configurations, each inference configuration of the one or more inference configurations comprising:
an indication of respective one or more first measurement objects for measurement; and
an indication of respective one or more second measurement objects for prediction;
send an applicability report comprising:
an indication of a first inference configuration of the one or more inference configurations; and
send a measurement report based on the first inference configuration.

10. The apparatus of claim 9, wherein:
each inference configuration of the one or more inference configurations comprises a respective inference configuration identifier; and
the indication of the first inference configuration comprises a first inference configuration identifier of the first inference configuration.

11. The apparatus of claim 9, wherein each inference configuration of the one or more inference configurations comprises a respective one or more measurement report configurations.

12. The apparatus of claim 9, wherein the first inference configuration comprises a network side additional condition associated with a first measurement object of the respective one or more first measurement objects or a second measurement object of the respective one or more second measurement objects.

13. The apparatus of claim 9, wherein:
the first inference configuration is associated with a first feature; and
a second inference configuration of the one or more inference configurations is associated with a second feature.

14. The apparatus of claim 13, wherein the first feature comprises one of a radio resource management prediction, an event prediction, a handover failure prediction, or a radio link failure prediction.

15. An apparatus comprising a processing system that includes one or more processors and one or more memories coupled with the one or more processors, the processing system configured to cause the apparatus to:
obtain configuration information comprising:
an indication of one or more measurement objects;
send an applicability report comprising:
an indication of one or more sets of measurement objects, wherein each set of the one or more sets of measurement objects comprises:
one or more respective measurement objects, of the one or more measurement objects, for measurement; and
one or more respective measurement objects, of the one or more measurement objects, for prediction;
obtain an inference configuration comprising:
an indication of one or more first measurement objects for measurement; and
an indication of one or more second measurement objects for prediction; and
send a measurement report based on the inference configuration.

16. The apparatus of claim 15, wherein:
the one or more measurement objects comprise:
at least one measurement object for measurement; and
at least one measurement object for prediction;
the one or more respective measurement objects for measurement are selected form the at least one measurement object for measurement; and
the one or more respective measurement objects for prediction are selected form the at least one measurement object for prediction.

17. The apparatus of claim 15, wherein the configuration information further comprises one or more measurement report configurations.

18. The apparatus of claim 17, wherein the applicability report further comprises an indication of one or more respective measurement report configurations, of the one or more measurement report configurations, associated with each set of the one or more sets of measurement objects.

19. The apparatus of claim 17, wherein the inference configuration comprises an indication of a first measurement report configuration of the one or more measurement report configurations.

20. The apparatus of claim 15, wherein the configuration information comprises a network side additional condition associated with a first measurement object of the one or more measurement objects.
